(19) United States
(12) Patent Application Publication
(10) Pub. No.: US 2026/0070417 A1
(43) Pub. Date: Mar. 12, 2026

(54) MANAGING RECREATIONAL VEHICLES AND ACCESSORIES

(71) Applicant: Polaris Industries Inc., Medina, MN (US)

(72) Inventors: Chiao George Liu, White Bear Lake, MN (US); Benjamin T. Edwards, North Branch, MN (US); Joseph D. Tharaldson, Taylor Falls, MN (US); Aidan B. Shaughnessy, Overland Park, KS (US); Joshua T. Weed, Stacy, MN (US); Timothy P. Norstad, Turtle Lake, WI (US); Jacob P. Horky, Shoreview, MN (US); Ngozi Okonkwo, Medina, MN (US); Charlie Raskob, Plymouth, MN (US); Ryan Nguyen, Medina, MN (US); Matthew Contons, Brooklyn Park, MN (US)

(21) Appl. No.: 19/324,641

(22) Filed: Sep. 10, 2025

Related U.S. Application Data
(60) Provisional application No. 63/692,752, filed on Sep. 10, 2024.

(51) Int. Cl. B60K 35/80; B60K 35/10; B60K 35/21; H04L 67/12

(52) U.S. Cl. CPC B60K 35/80; B60K 35/10; B60K 35/21; H04L 67/12; B60K 2360/115; B60K 2360/168

(57) ABSTRACT

A vehicle includes a frame, a plurality of ground engaging members coupled to the frame; a removable accessory; and a controller storing instructions that, when executed by the controller, cause the controller to adapt a state of the removable accessory.

### CLAIM OF PRIORITY AND INCORPORATION BY REFERENCE

The present application claims the benefit of priority under 35 U.S.C. § 119 (e) of U.S. Provisional Patent Application 63/692,752, filed Sep. 10, 2024, the disclosure of which is hereby incorporated by reference herein in its entirety.

### FIELD OF DISCLOSURE

The present disclosure relates to recreational vehicles and accessories, and in particular to systems and methods for connecting accessories to a recreational vehicle, controlling accessories, and/or displaying the connected accessories on a user interface of the vehicle.

### BACKGROUND OF THE DISCLOSURE

Recreational vehicles, such as motorcycles, all-terrain vehicles (ATVs), side-by-side vehicles, utility vehicles, and snowmobiles, are widely used for recreational purposes. These vehicles might be used on-road and/or off-road, such as trails.

Recreational vehicles with display screens are known. Systems and methods for displaying customized information regarding a recreational vehicle are disclosed in US Published Patent Application 2017/0334500 (filed May 23, 2016, titled DISPLAY SYSTEMS AND METHODS FOR A RECREATIONAL VEHICLE), the entire disclosure of which is expressly incorporated by reference herein.

### SUMMARY OF THE DISCLOSURE

Some embodiments of the present disclosure provide a method for controlling a removable accessory of a vehicle. The method includes: receiving an indication of a first angle setting for a removable accessory of the vehicle; actuating the removable accessory to a first angle corresponding to the first angle setting; after actuating the removable accessory to the first angle, receiving an indication of the removable accessory not being at the first angle; and re-actuating the removable accessory to the first angle corresponding to the first angle setting.

Some embodiments of the present disclosure provide a vehicle. The vehicle includes a frame; a plurality of ground engaging members coupled to the frame; one or more actuators coupled to the frame; a removable accessory; and a controller storing instructions that, when executed by the controller, cause the controller to perform a set of operations. The set of operations include: receiving an indication of a first angle setting for the removable accessory; actuating the removable accessory to a first angle corresponding to the first angle setting, via the one or more actuators; after actuating the removable accessory to the first angle, receiving an indication of the removable accessory not being at the first angle; and re-actuating the removable accessory to the first angle corresponding to the first angle setting, via the one or more actuators.

Some embodiments of the present disclosure provide a method for interfacing with vehicle accessories. The method includes receiving an inbound communication. The inbound communication is received via a first communication protocol. The method further includes translating the inbound communication into an outbound communication, such that one or more data packets of the inbound communication are readable in the outbound communication via a second communication protocol that is different than the first communication protocol; and transmitting the outbound communication via the second communication protocol.

Some embodiments of the present disclosure provide a vehicle. The vehicle includes: a frame; a plurality of ground engaging members coupled to the frame; one or more removable accessories; and a controller storing instructions that, when executed by the controller, cause the controller to perform a set of operations. The set of operations include: displaying a graphical user interface (GUI). The GUI includes one or more visual indicators. Each visual indicator of the one or more visual indicators corresponds to a respective removable accessory of the one or more removable accessories. Each visual indicator is configurable such that user input corresponding to a first visual indicator of the one or more visual indicators enables adapting a state of a respective first removable accessory corresponding to the first visual indicator. The set of operations further includes: determining to limit configurability of at least one removable accessory of the one or more removable accessories; and limiting the configurability of the at least one removable accessory and also of each visual indicator of the one or more visual indicators that corresponds to a respective removable accessory of the at least one removable accessory.

Some embodiments of the present disclosure provide a vehicle. The vehicle includes: a frame; a plurality of ground engaging members coupled to the frame; a plurality of removable accessories; and a user interface. The user interface includes a touchscreen display and a plurality of user input devices. The vehicle further includes a controller storing instructions that, when executed by the controller, cause the controller to perform a set of operations. The set of operations include displaying a graphical user interface (GUI), via the touchscreen display. The GUI includes a plurality of visual indicators. Each visual indicator of the plurality of visual indicators is selectable via the touchscreen display. The set of operations further includes: receiving a customized mapping from at least one removeable accessory of the plurality of removeable accessories to both a first visual indicator of the plurality of visual indicators and a first user input device of the plurality of user input devices; and configuring each removeable accessory of the at least one removeable accessories to be adaptable via the first visual indicator and to be adaptable via the first user input device.

Some embodiments of the present disclosure provide a vehicle. The vehicle includes: a frame; a plurality of ground engaging members coupled to the frame; a plurality of removable accessories; and a user interface. The user interface includes a display; and a controller storing instructions that, when executed by the controller, cause the controller to perform a set of operations. The set of operations include displaying a graphical user interface (GUI), via the display. The GUI includes a plurality of visual indicators. Each visual indicator of the plurality of visual indicators is selectable. The set of operations further includes: receiving a customized mapping from at least a first removeable accessory of the plurality of removeable accessories to a first visual indicator of the plurality of visual indicators and from at least a second removeable accessory of the plurality of removeable accessories to a second visual indicator of the plurality of visual indicators; and configuring each removeable accessory of the at least a first removeable accessory to be adaptable via the first visual indicator and each removable accessory of the at least a second removable accessory to be adaptable via the second visual indicator.

Some embodiments of the present disclosure provide a vehicle. The vehicle includes: a frame; a plurality of ground engaging members coupled to the frame; a controller area network (CAN) bus; and an accessory controller in communication with the CAN bus. Other types of networks and protocols, including but not limited to a local interconnect network (LIN), Automotive Ethernet, or WiFi, may be used without departing from the scope of the present subject matter. The accessory controller includes a processor and memory. The vehicle further includes a plurality of removable accessories operatively coupled to the accessory controller. The accessory controller is configured to receive one or more communications from the CAN bus to adapt at least one of the plurality of removeable accessories.

Some embodiments of the present disclosure provide a vehicle. The vehicle includes: a frame; a plurality of ground engaging members coupled to the frame; a controller area network (CAN) bus; and an accessory controller in communication with the CAN bus. The accessory controller includes a processor and memory. The vehicle further includes: a plurality of removable accessories operatively coupled to the accessory controller; and one or more input devices operatively coupled to the accessory controller. The one or more input devices are configured to transmit one or more communications, via the accessory controller, to adapt at least one of the plurality of removeable accessories.

Some embodiments of the present disclosure provide a vehicle. The vehicle includes: a frame; a plurality of ground engaging members coupled to the frame; a controller area network (CAN) bus; and an accessory controller in communication with the CAN bus. The accessory controller includes a processor and memory. The vehicle further includes a plurality of removable accessories operatively coupled to the accessory controller. The plurality of removable accessories include an auxiliary power source. The auxiliary power source is configured to power at least one other removable accessory of the plurality of removable accessories via the accessory controller.

Some embodiments of the present disclosure provide a method for configuring an accessory controller. The method includes providing the accessory controller for the vehicle. The accessory controller includes a processor, a memory, and a plurality of ports. Each port of the plurality of ports is sized and shaped to receive a respective coupling with a removable accessory of the vehicle. The method further includes: receiving, at a first port of the plurality of ports, a coupling with a first removable accessory of the vehicle; displaying a port configuration user interface on a display screen of the vehicle; receiving an indication of one or more inputs on the port configuration user interface; and customizing adaptability of the first removable accessory, based on the received indication of one or more inputs on the port configuration user interface.

Some embodiments of the present disclosure provide a method for intelligent plowing with a vehicle. The method includes receiving, at a controller of the vehicle, operator input specifying a desired plowing outcome, the operator input including at least one of a predetermined location or direction for plowed material. The method further includes determining, based on vehicle position and orientation data, a plow position and angle required to achieve the specified plowing outcome, automatically actuating the plow to the determined position and angle, and adjusting the plow position and angle in real time as the vehicle moves, based on updated vehicle position and orientation data, to continuously direct plowed material toward the specified location or direction.

Some embodiments of the present disclosure provide a wireless smart accessory system for a vehicle. The system includes a wireless hub configured to communicate with at least one smart device via a wireless communication protocol, where the smart device comprises at least one of a smart plug, a smart relay, a smart switch, or a smart accessory. The wireless hub is further configured to receive control inputs from a remote user interface and transmit control signals to the smart device to adapt a state of at least one accessory operatively coupled to the smart device, without requiring direct integration with vehicle wiring or vehicle control systems.

Some embodiments of the present disclosure provide a method for digital accessory mode selection in a vehicle. The method includes receiving, at a controller, a user input indicating a specified mode for an accessory, determining, based on a current mode of the accessory, a required number of mode selection signals to transition the accessory from the current mode to the specified mode, and automatically transmitting the required number of mode selection signals from the controller to the accessory to transition the accessory to the specified mode in response to the single user input.

Some embodiments of the present disclosure provide an accessory light audio system for a vehicle. The system includes a light module configured to emit illumination in response to control signals, and an audio module mounted in the vehicle and configured to process music input. The system further includes a controller operatively coupled to the light module and the audio module, where the controller is configured to receive a processed audio signal from the audio module and to generate control signals to the light module, such that the illumination is adapted in response to the music input.

Some embodiments of the present disclosure provide an apparatus for semi-integrated Bluetooth control in a vehicle. The apparatus includes a Bluetooth-enabled control interface configured for removable attachment to a steering wheel or other accessible vehicle surface, and a rechargeable battery integrated within the control interface. The control interface is further configured to wirelessly transmit control signals to one or more external devices in response to user actuation of the buttons.

Some embodiments of the present disclosure provide a Bluetooth integrated dash switch system for a vehicle. The system includes a switch bank comprising a plurality of user-operable switches, the switch bank configured for installation on a vehicle dashboard, and a Bluetooth communication module operatively coupled to the switch bank and configured to wirelessly transmit control signals to one or more accessories in response to actuation of the switches. The switch bank is powered via a vehicle power source and is not physically electrically linked to the accessories.

Additional features of the present disclosure will become apparent to those skilled in the art upon consideration of the following detailed description of illustrative embodiments exemplifying the best mode of carrying out the invention as presently perceived.

### BRIEF DESCRIPTION OF THE DRAWINGS

The foregoing aspects and many additional features of the present system and method will become more readily appreciated and become better understood by reference to the following detailed description when taken in conjunction with the accompanying drawings, where:

FIG. 1 is a representative view of an example vehicle.

FIG. 2 is a representative view of an example power system of the vehicle of FIG. 1.

FIG. 3 is a representative view of example components of the vehicle of FIG. 1, including a vehicle controller.

FIG. 4 illustrates example accessories that may be operatively coupled to the vehicle of FIG. 1.

FIG. 5 is a front perspective view of another example vehicle, such as a two-wheeled vehicle.

FIG. 6 is a front perspective view of another example vehicle, such as a four-wheeled vehicle.

FIG. 7 is a front perspective view of another example vehicle, such as an all-terrain vehicle.

FIG. 8 is a front perspective view of another example vehicle, such as a three-wheeled vehicle.

FIG. 9 is a front perspective view of another example vehicle, such as a utility vehicle.

FIG. 10 is a front perspective view of another example vehicle, such as a snowmobile.

FIG. 11 illustrates an example control system for controlling the one or more accessories.

FIG. 12 illustrates an example method for controlling a removable accessory of a vehicle.

FIG. 13 illustrates an example user interface, according to some embodiments of the present disclosure.

FIG. 14 illustrates an example method for interfacing accessories with a vehicle.

FIG. 15 illustrates an example system for interfacing accessories with a vehicle.

FIG. 16 illustrates an example method for limiting configurability of one or more accessories of a vehicle.

FIG. 17A illustrates an example user interface, according to some embodiments of the present disclosure.

FIG. 17B illustrates another view of the example user interface, according to some embodiments of the present disclosure.

FIG. 18 illustrates an example method for mapping removable accessories of a vehicle to visual indications on a display.

FIG. 19 illustrates an example method for mapping removable accessories of a vehicle to visual indications on a display.

FIG. 20 illustrates an example system according to some embodiments of the present disclosure.

FIG. 21 illustrates a detailed schematic of an accessory control module from the system of FIG. 20.

FIG. 22 illustrates another view of the example system of FIG. 20 according to some embodiments of the present disclosure.

FIG. 23 illustrates an example method for configuring an accessory controller for a vehicle, according to some embodiments of the present disclosure.

FIG. 24 illustrates an example user interface, according to some embodiments of the present disclosure.

FIG. 25 illustrates an example intelligent plowing system for a vehicle, according to some embodiments of the present disclosure.

FIGS. 26A-26F illustrate various examples of a wireless smart accessory system for a vehicle, according to some embodiments of the present disclosure.

FIG. 27 illustrates a digital accessory mode selection system for a vehicle, according to some embodiments of the present disclosure.

FIG. 28 illustrates an accessory light audio system for a vehicle, according to some embodiments of the present disclosure.

FIG. 29 illustrates an apparatus for semi-integrated wireless control in a vehicle, according to some embodiments of the present disclosure.

FIG. 30 illustrates a Bluetooth integrated dash switch system for a vehicle, according to some embodiments of the present disclosure.

### DETAILED DESCRIPTION OF EMBODIMENTS

For the purposes of promoting an understanding of the principles of the present disclosure, reference will now be made to the embodiments illustrated in the drawings, which are described below. The embodiments disclosed below are not intended to be exhaustive or limited to the precise form disclosed in the following detailed description. Rather, the embodiments are chosen and described so that others skilled in the art may utilize their teachings.

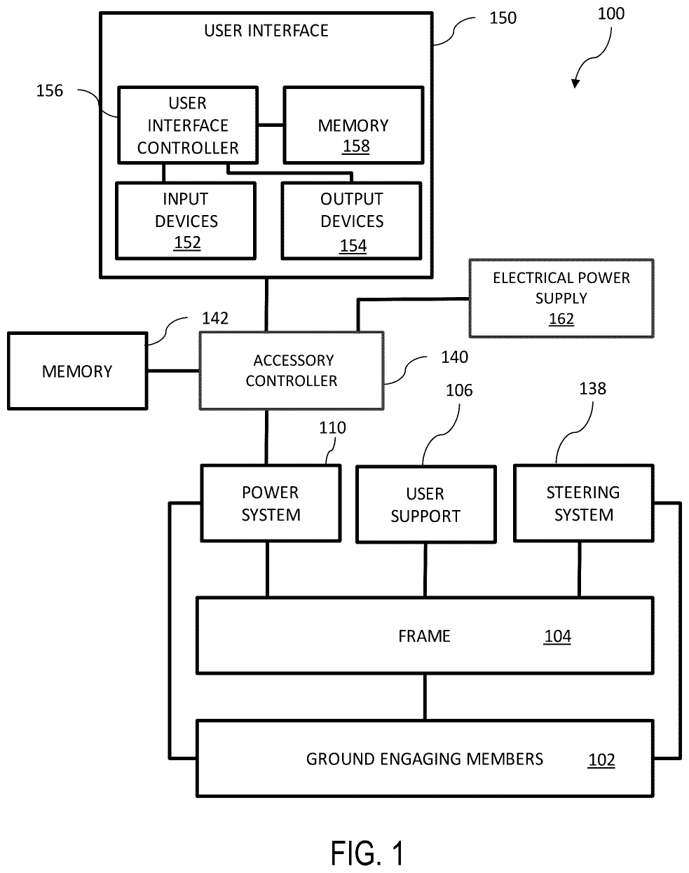

Referring to FIG. 1, an example recreational vehicle 100 is provided. Recreational vehicle 100 includes a plurality of ground engaging members 102. Example ground engaging members include skis, endless tracks, wheels, and other suitable devices which support vehicle 100 relative to the ground. Recreational vehicle 100 further includes a frame 104 supported by the plurality of ground engaging members 102. In one embodiment, frame 104 includes cast portions, weldments, tubular components or a combination thereof. In one embodiment, frame 104 is a rigid frame. In one embodiment, frame 104 has at least two sections which are moveable relative to each other.

A user support 106 is supported by frame 104. Example user supports include straddle seats, bench seats, bucket seats, and other suitable support members. In addition to user support 106, recreational vehicle 100 may further include a passenger support. Example passenger supports include straddle seats, bench seats, bucket seats, and other suitable support members.

A power system 110 is supported by frame 104. Power system 110 provides the motive force and communicates the same to at least one of the ground engagement members 102 to power movement of recreational vehicle 100.

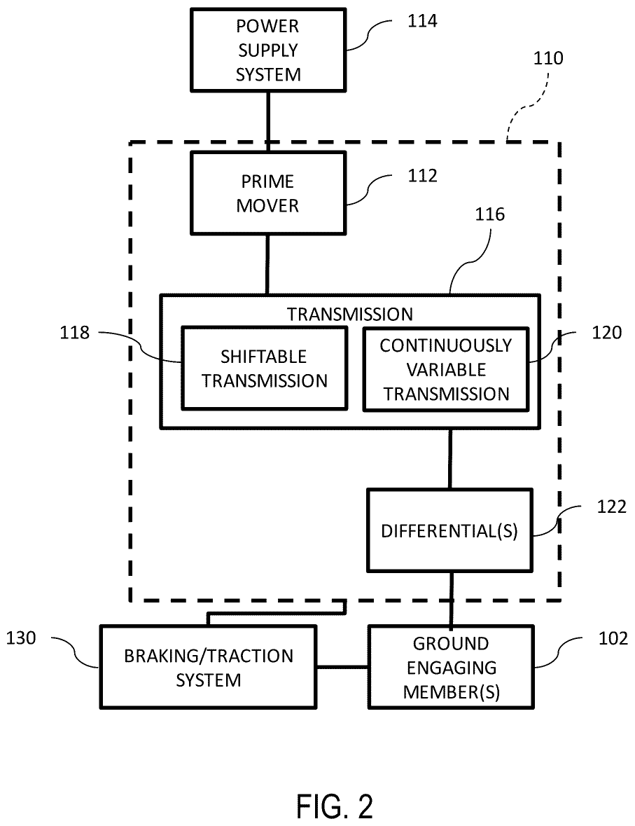

Referring to FIG. 2, an example embodiment of power system 110 is illustrated. Power system 110 includes a prime mover 112. Example prime movers 112 include internal combustion engines, two stroke internal combustion engines, four stroke internal combustion engines, diesel engines, electric motors, hybrid engines, and other suitable sources of motive force. To start the prime mover 112, a power supply system 114 is provided. The type of power supply system 114 depends on the type of prime mover 112 used. In one embodiment, prime mover 112 is an internal combustion engine and power supply system 114 is one of a pull start system and an electric start system. In one embodiment, prime mover 112 is an electric motor and power supply system 114 is a switch system which electrically couples one or more batteries to the electric motor.

A transmission 116 is coupled to prime mover 112. Transmission 116 is illustrated as having a shiftable transmission 118 and a continuously variable transmission (“CVT”) 120. CVT 120 is coupled to prime mover 112. Shiftable transmission 118 is in turn coupled to CVT 120. In one embodiment, shiftable transmission 118 includes a forward high setting, a forward low setting, a neutral setting, a park setting, and a reverse setting. The power communicated from prime mover 112 to CVT 120 is provided to a drive member of CVT 120. The drive member in turn provides power to a driven member through a belt. Example CVTs are disclosed in U.S. Pat. Nos. 3,861,229; 6,176,796; 6,120,399; 6,860,826; and 6,938,508, the disclosures of which are expressly incorporated by reference herein. The driven member provides power to an input shaft of shiftable transmission 118. Although transmission 116 is illustrated as including both shiftable transmission 118 and CVT 120, transmission 116 may include only one of shiftable transmission 118 and CVT 120. Additionally, and/or alternatively, in some examples, the transmission 116 does not include a CVT 120 and another type of transmission is included. For example, other types of transmissions include, but are not limited to, automatic transmissions, manual transmissions, and/or automated manual transmissions.

In the illustrated embodiment, transmission 116 is further coupled to at least one differential 122 which is in turn coupled to at least one ground engaging member 102. Differential 122 may communicate the power from transmission 116 to one of ground engaging members 102 or multiple ground engaging members 102. In an ATV embodiment, one or both of a front differential and a rear differential are provided. The front differential operatively couples at least one of two front wheels of the ATV to transmission 116 and the rear differential operatively couples at least one of two rear wheels to transmission 116. In a utility vehicle embodiment, one or both of a front differential and a rear differential are provided. The front differential operatively couples at least one of two front wheels of the utility vehicle to transmission 116 and the rear differential operatively couples at least one of multiple rear wheels of the utility vehicle to the transmission 116. In one example, the utility vehicle has three axles and a differential is provided for each axle. In a motorcycle embodiment, a differential 122 and CVT 120 are not generally included. Rather, shiftable transmission 118 is coupled to at least one rear wheel through a chain or belt. In another motorcycle embodiment, a differential 122 is not included. Rather, CVT 120 is coupled to at least one rear wheel through a chain or belt. In a snowmobile embodiment, a differential 122 is not included. Rather, CVT 120 is coupled to an endless track through a chain case. In some embodiments, such as a golf cart embodiment, a transmission is not included. Rather, an electric motor can be coupled directly to a differential 122. An example differential is a helical gear set. The motor can be run in a first direction for forward operation of the golf cart and in a second direction for reverse operation of the golf cart. Although mentioned in connection with a golf cart, the concepts described herein may be used in connection with any electric vehicle.

Recreational vehicle 100 further includes a braking/traction system 130. In one embodiment, braking/traction system 130 includes anti-lock brakes. In one embodiment, braking/traction system 130 includes active descent control and/or engine braking. In one embodiment, braking/traction system 130 includes a brake and in some embodiments a separate parking brake. Braking/traction system 130 may be coupled to any of prime mover 112, transmission 116, differential 122, and ground engaging members 102 or the connecting drive members therebetween.

Returning to FIG. 1, recreational vehicle 100 further includes a steering system 138. Steering system 138 is coupled to at least one of the ground engagement members 102 to direct recreational vehicle 100. Steering system 138 generally includes a steering member adapted to be grasped by a user of vehicle 100. Example steering members include handlebars and steering wheels.

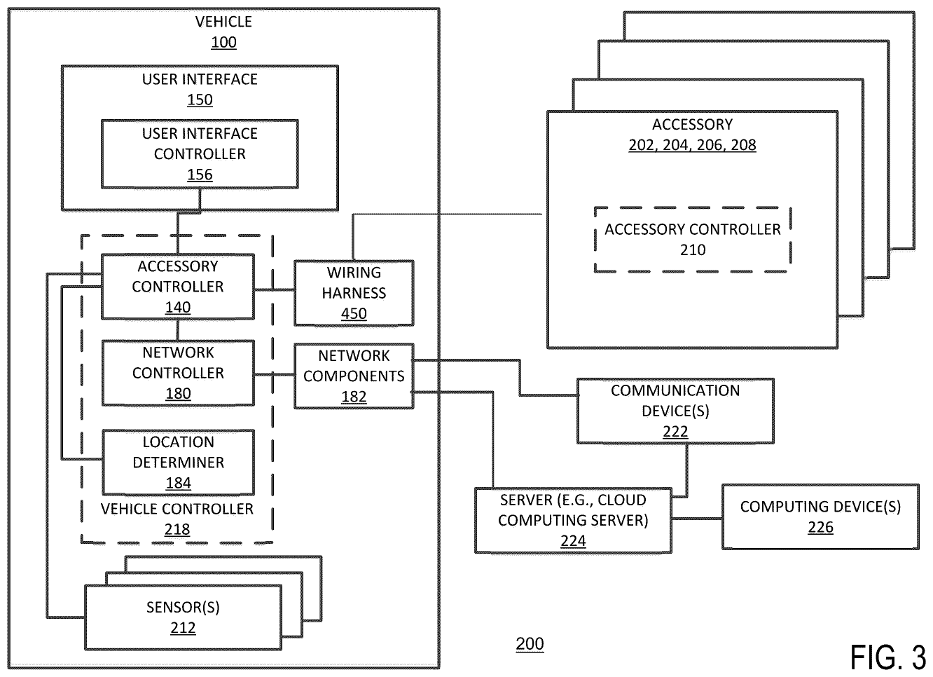

Further, recreational vehicle 100 includes a controller 140, such as an accessory controller, having at least one associated memory 142. The accessory controller 140 provides the electronic control of the various components of recreational vehicle 100, such as the providing control of the user interface 150 and/or components of the user interface 150. Further, the accessory controller 140 is operatively coupled to a plurality of sensors 212 (see FIG. 3) which monitor various parameters of recreational vehicle 100 or the environment surrounding vehicle 100. In some examples, the accessory controller 140 forms a portion of a processing subsystem including one or more computing devices having memory, processing, and communication hardware. The accessory controller 140 may be a single device or a distributed device, and the functions of the accessory controller 140 may be performed by hardware and/or as computer instructions on a non-transient computer readable storage medium, such as memory 142.

The accessory controller 140, such as an accessory control module, also interacts with a user interface 150 which includes at least one input device 152 and at least one output device 154. Example input devices 152 include levers, buttons, switches, soft keys, selectors, knobs, dials, joysticks, inputs from frequency operated button (FOB), hard keys, and other suitable input devices. Example output devices 154 include lights, displays, touch screens, audio devices, tactile devices, and other suitable output devices. User interface 150 further includes a user interface controller (controller) 156 and an associated memory 158. Interface controller 156 performs certain operations to control one or more subsystems of user interface 150 or of other vehicle components, such as one or more of input devices 152 and output devices 154. In some examples, user interface 150 includes a touch screen display and interface controller 156 interprets various types of touches to the touch screen display as inputs and controls the content displayed on touch screen display. In some instances, interface controller 156 forms a portion of a processing subsystem including one or more computing devices having memory, processing, and communication hardware. The interface controller 156 may be a single device or a distributed device, and the functions of the interface controller 156 may be performed by hardware and/or as computer instructions on a non-transient computer readable storage medium, such as memory 158.

In some examples, output devices 154 include a display and interface controller 156 formats information to be displayed on the display and causes displays of the information on the output device 154. In some variations, output devices 154 include a touch display and interface controller 156 formats information to be displayed on the touch display, displays the information, and monitors the touch display for user input. Example user inputs include a touch, a drag, a swipe, a pinch, a spread, and other known types of gesturing.

The accessory controller 140 is operatively coupled to an electrical power supply 162. The electrical power supply 162 may be any type of electrical power supply, including a battery, a high voltage bus, stators, regulators, ferrous cores, solar components, and/or any other type of alternative power methods and/or sources. The electrical power supply 162 provides power to operate the vehicle 100. Additionally, and/or alternatively, the electrical power supply 162 is operatively coupled to the user interface 150 (e.g., the user interface controller 156), the power system 110, and/or additional components of the vehicle 100. For example, the electrical power supply 162 may be electrically connected to components of the vehicle 100 via a network (e.g., a vehicle bus and/or a controller area network (CAN), which is described below).

FIG. 3 illustrates an example block diagram of a vehicle system 200 for use with a removable accessory, such as accessory 202, 204, 206, 208. Referring to FIG. 3, the accessory controller 140 is included within a vehicle controller 218 (e.g., an electronic control module). The vehicle controller 218 further includes a network controller 180. However, while not illustrated, additional controllers, such as a suspension controller, a steering system controller, and/or a power system controller, may be included within the vehicle controller 218. Each of these controllers, including the vehicle controller 218, may each be single devices or distributed devices or one or more of these controllers may together be part of a single device or distributed device. The functions of these controllers may be performed by hardware and/or as computer instructions on a non-transient computer readable storage medium, such as memory 142. Additionally, and/or alternatively, memory, such as memory 142, may be included within the vehicle controller 218. In other words, the controllers within the vehicle controller 218 may use the memory 142 to store and/or retrieve information.

In some variations, the vehicle controller 218 includes at least two separate controllers (e.g., network controller 180 and/or the accessory controller 140) that communicate over a network. In some instances, the network is a controller area network (CAN). In some variations, the CAN network is implemented in accord with the society of automotive engineers standard J1939 protocol. Details regarding an example CAN network are disclosed in U.S. patent application Ser. No. 11/218,163, filed Sep. 1, 2005, the disclosure of which is expressly incorporated by reference herein. Other example networks or other suitable data connections may be implemented in place of the CAN network. For example, in embodiments, a two wire serial communication is used to communicate between the controllers. In some examples, the vehicle controller 218 communicates with other devices and/or entities within the vehicle 100 via a network, such as the CAN network described above.

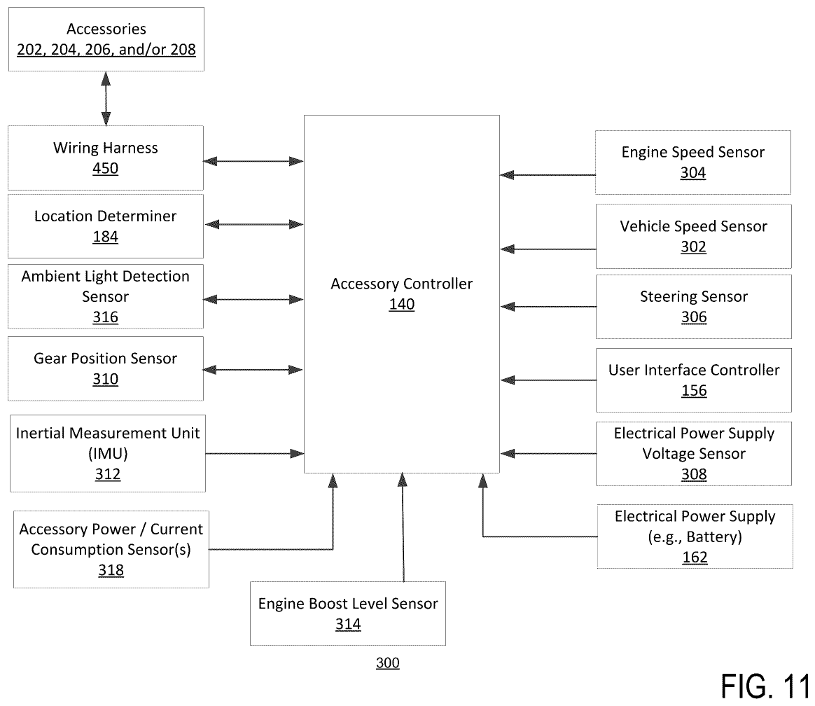

In examples, the accessory controller 140 may communicate with one or more sensors 212, the electrical power supply 162, and/or the user interface 150. Additionally, and/or alternatively, the accessory controller 140 may communicate directly and/or indirectly (e.g., through the user interface controller 156) to components within the user interface 150, such as the input devices 152, memory 158, and/or the output devices 154. Example sensors 212 of the vehicle 100, including the types of sensors within the vehicle 100 are disclosed herein, see FIG. 11. Other example networks or other suitable data connections may be implemented in place of the CAN network and used to communicate between the entities and/or device within the vehicle 100 and the controller 218.

Controller 218 further includes a network controller 180 that controls communications between recreational vehicle 100 and other devices through one or more network components 182. In embodiments, network controller 180 of recreational vehicle 100 communicates with devices via a network, such as a Wi-Fi network (which can include one or more wireless routers, one or more switches, etc.), a peer-to-peer network (e.g., a Bluetooth or Bluetooth Low Energy network), a cellular network (e.g., a 3G network, a 4G network, a 5G network, etc., complying with any suitable standard), a wired network, etc. In some examples, the network can be a local area network (LAN), interfaces conforming known communications standard, such as Bluetooth® standard, IEEE 802 standards (e.g., IEEE 802.11), a ZigBee® or similar specification, such as those based on the IEEE 802.15.4 standard, a wide area network (WAN), a public network (e.g., the Internet), a private or semi-private network, any other suitable type of network, or any suitable combination of networks. In some examples, network components 182 include a radio frequency antenna. In some examples, network controller 180 controls the pairing of devices and/or servers to recreational vehicle 100 and the communications between recreational vehicle 100 and the remote devices. In some examples, the network controller 180 controls and/or provides communication between multiple different recreational vehicles (e.g., vehicle-to-vehicle communication).

Example remote devices include, but are not limited to, a communication device 222 (e.g., a mobile phone, smartphone, wearable device), a server 224 (e.g., a cloud computing server), and/or a computing device 226 (e.g., a laptop, desktop, and/or other personalized computers). As illustrated in FIG. 3, the cloud computing server 224 connects the computing device 226 to the network controller 180. For example, the network controller 180 provides information to a cloud computing server 224. Furthermore, based on the information, the cloud computing server 224 may store the information. The computing device 226 may receive (e.g., obtain and/or retrieve) the information from the cloud computing server 224. Additionally, and/or alternatively, while not shown in FIG. 3, the computing device 226 may directly connect to the network controller 180 via the network components 182 to communicate with the vehicle 100. Furthermore, in embodiments, the server 224 may be in communication with the communication device 222. In other words, the communication device 222 may receive and/or transmit information from either the server 224 and/or the vehicle 100.

In some examples, example communication devices 222 include, but are not limited to, cellular telephones, smartphones, tablets, wearable computing devices, satellite telephones, audio interface devices, and/or other devices capable of sending and receiving communications through external networks. Example audio interface devices include headsets including a microphone to receive audio and convert the audio to electronic signals and a speaker to convert electronic signals into audio. In some instances, the example communication devices 222 include one or more displays that display information, such as information regarding the vehicle 100. The network controller 180 may provide instructions to the communication device 222 to cause display of the vehicle information on the display screens of the device 222.

Controller 218 further includes a location determiner 184 which determines a current location of recreational vehicle 100. An example location determiner 184 is a GPS unit which determines the position of recreational vehicle 100 based on interaction with a global satellite system.

The accessory controller 140 is connected to one or more accessories 202, 204, 206, and/or 208 via a wiring harness 450. Accessories are any suitable component, assembly, and/or device that can be powered and/or controlled by the vehicle 100 (e.g., by the accessory controller 140 and/or the user interface controller 156). In embodiments, accessories may be added to the vehicle during factory assembly of the vehicle and/or subsequent to vehicle delivery to a dealer, customer, or other individual or entity. Example accessories include components, assemblies, and/or devices that are required for vehicle motive operation relative to the ground (although replaceable with other accessories or components, assemblies, and/or devices that are not powered and/or controlled by the vehicle) and components, assemblies, and/or devices that are not required for vehicle motive operation relative to the ground (although replaceable with other accessories or components, assemblies, and/or devices that are not powered and/or controlled by the vehicle) and which otherwise provide altered (additional or diminished) vehicle functionality, altered (additional or diminished) vehicle performance, and/or additional alterations to the vehicle capabilities. Example accessories required for vehicle motive operation include shocks, ride height adjuster, electronic CVT (ECVT), and other suitable accessories. Example accessories not required for vehicle motive operation include lights, winch, sprayer, plow, HVAC system, and other suitable accessories. Example accessories are disclosed throughout. Additional and/or alternative accessories for a vehicle should be recognized by those of ordinary skill in the art, such as disclosed in U.S. Patent Publication No. 2020/0198467A1 filed on Sep. 4, 2019, and entitled “Managing Recreational Vehicles and Accessories,” the entire disclosure of which is expressly incorporated by reference herein.

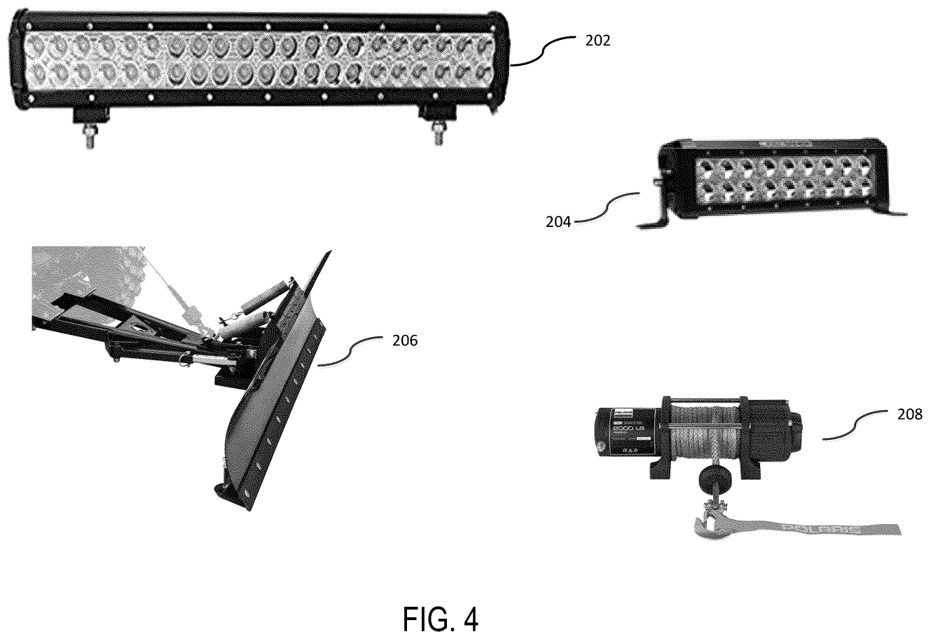

FIG. 4 illustrates various example accessories. For example, accessory 202 is a 30-inch light bar, accessory 204 is a 10-inch light bar, accessory 206 is a plow, and accessory 208 is a winch. However, the accessories shown in FIG. 4 are merely examples, and other types of accessories not shown in FIG. 4 may also be powered and/or controlled by the vehicle 100, and in particular the user interface controller 156 and/or the accessory controller 140. For example, additional accessories include, but are not limited to, rock lights, light emitting diode (LED) whips, work lights, rear lights, head/tail lights with turn signals, sprayers, salt spreaders, plows, motorcycle windshield, power seats, power windows, and/or motorcycle puddle lights. In some examples below, only accessories 202-208 are described. However, it should be understood that the accessory controller 140 and/or the user interface controller 156 may operate any accessories, including any of the accessories listed above. For example, the controller 140 and/or controller 156 may identify the accessories, control the accessories, and/or provide/terminate and/or reduce power to the accessories. Further, even if accessory 202-208 are described below, it should be understood that the accessory or accessories can be any type of accessory, including, but not limited to, accessories listed above and/or other types of accessories that may be connected to the vehicle 100.

Returning to FIG. 3, the wiring harness 450 is any type and/or combination of harness, relays, switches, wires, connectors, and/or transmitters that connects the accessories to the accessory controller 140. As shown, the wiring harness 450 connects the accessories 202, 204, 206, 208 to the accessory controller 140. In some examples, the wiring harness 450 directly connects the accessories to the user interface controller 156. In some examples, one or more of the accessories may also include an accessory controller 210. The accessory controller 210 may receive information from the accessory controller 140 and/or the user interface controller 156 and be configured to control the corresponding accessory. The wiring harness 450, the accessories, and the accessory controller 210 will be described in further detail below.

Although the accessory controller 140 and interface controller 156 are illustrated separately in FIG. 3, their functionality may be combined (e.g., the interface controller 156 may be included within the vehicle controller 218 and/or within the accessory controller 140). Further, a portion or all of the functionality of one or more of network controller 180 and location determiner 184 may be included as part of interface controller 156 and/or accessory controller 140. In one embodiment, it is desired to include the functionality of network controller 180 and location determiner 184 as part of interface controller 156 to provide components that are easily replaceable or upgradable. Throughout this application, various features and functionality are described in connection with the accessory controller 140, vehicle controller 218, interface controller 156, or generally a vehicle associated controller. Any of the vehicle controller 218, the accessory controller 140, and interface controller 156 may provide the described features and functionality unless stated otherwise.

Referring to FIG. 1, memory in the vehicle 100, such as memory 142 or memory 158, has computer-readable media in the form of volatile and/or nonvolatile memory and is removable, nonremovable, a combination, and/or non-transitory. Media examples include Random Access Memory (RAM); Read Only Memory (ROM), Electronically Erasable Programmable Read Only Memory (EEPROM), flash memory, optical or holographic media, magnetic storage devices, and/or any other medium that can be used to store information and can be accessed by an electronic device. Additionally, and/or alternatively, memory 142 and/or memory 158 are representative of multiple memories, and each memory is attached to a different device and/or component of the user interface 150, the vehicle controller 218, and/or another device/component within the vehicle 100.

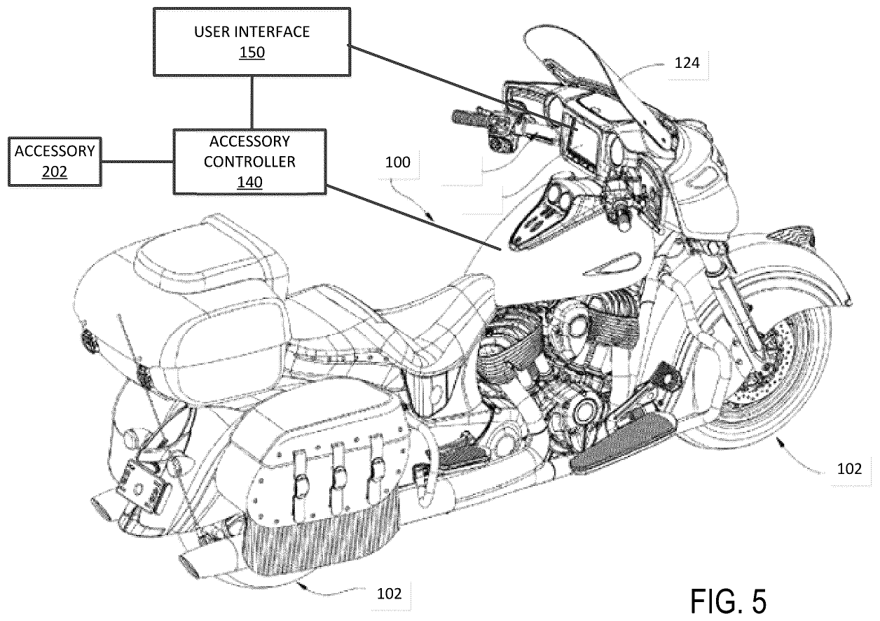

Referring to FIG. 1, the vehicle 100 is any vehicle, such as a two wheel vehicle, a three wheel vehicle, a four wheel vehicle, and/or other multi-wheeled recreational vehicle that is used on roads, trails, and/or both. Some examples of the vehicles include, but are not limited to, motorcycles, all-terrain vehicles (ATVs), Jeep-type vehicles, side-by-side recreational vehicles, snowmobiles and utility vehicles. FIGS. 5-10 illustrate different embodiments of vehicles 100 that are configured to connect to different accessories and/or control (e.g., provide commands and/or power) the accessories. However, the vehicles shown in FIGS. 5-10 are non-exhaustive, and other types of vehicles are contemplated within this disclosure.

FIG. 5 illustrates the vehicle 100 as a two-wheeled vehicle, such as a motorcycle. The motorcycle 100 includes two ground engaging members (wheels) 102. Further, the motorcycle includes a windshield 124 and a user interface (e.g., display) 150. As mentioned previously, the user interface 150 may include input devices 152 (e.g., hard buttons and/or soft buttons), output devices 154 (e.g., a display), memory 158 and/or a user interface controller 156 configured to receive input from the input devices 152 and/or cause display of images on the output devices 154.

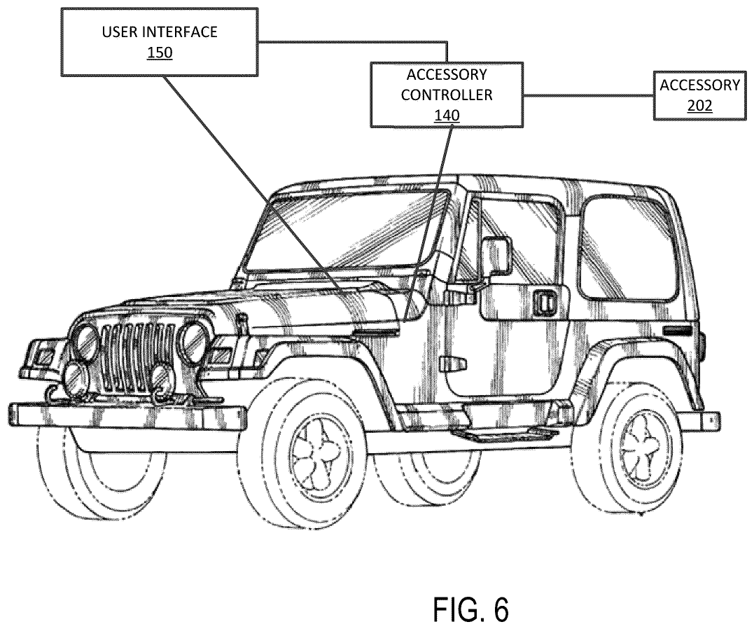

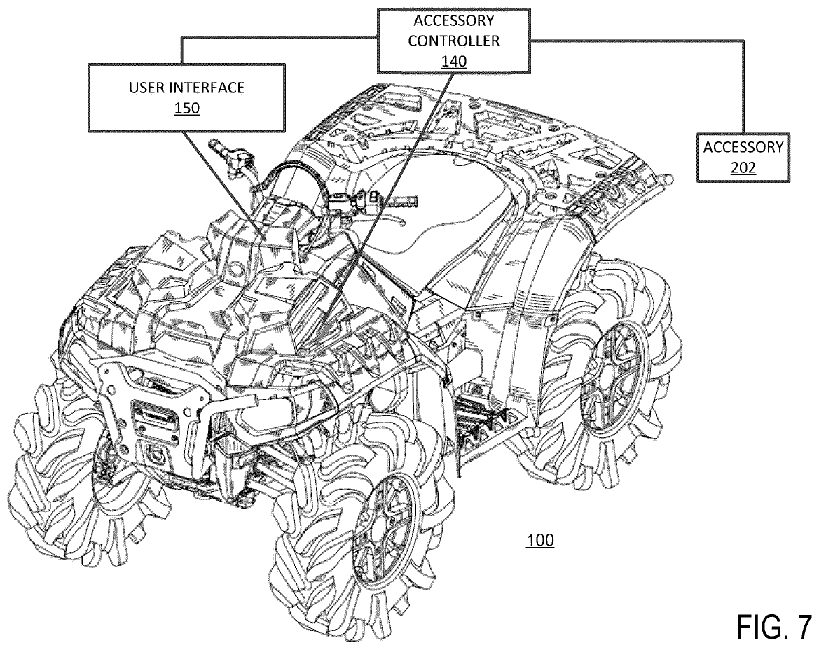

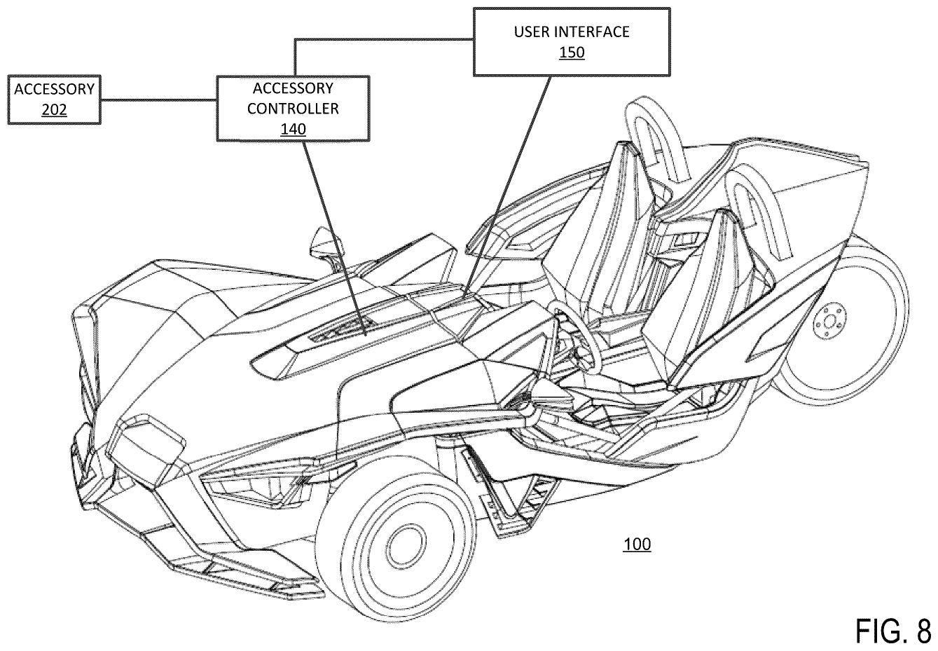

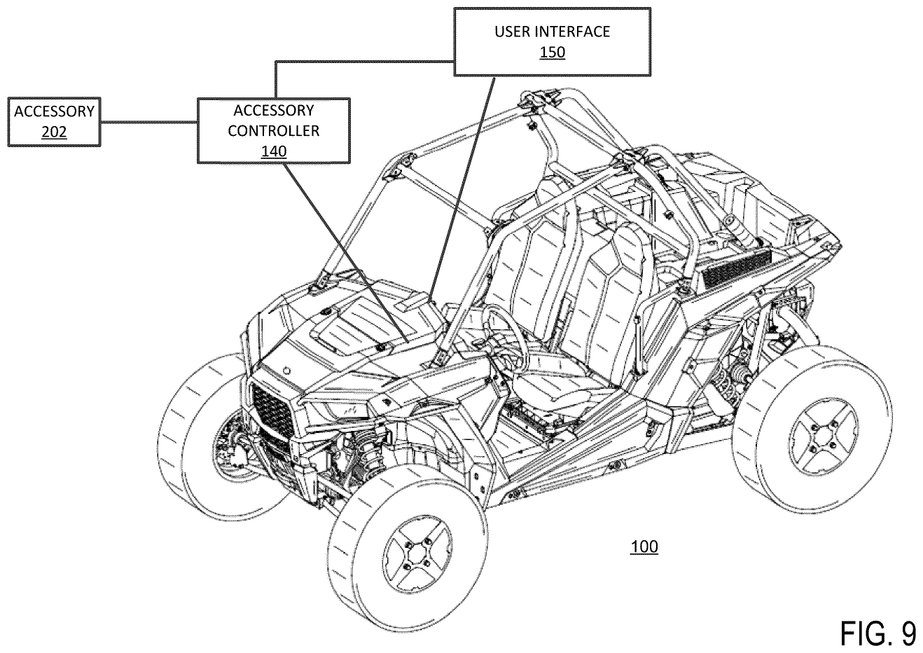

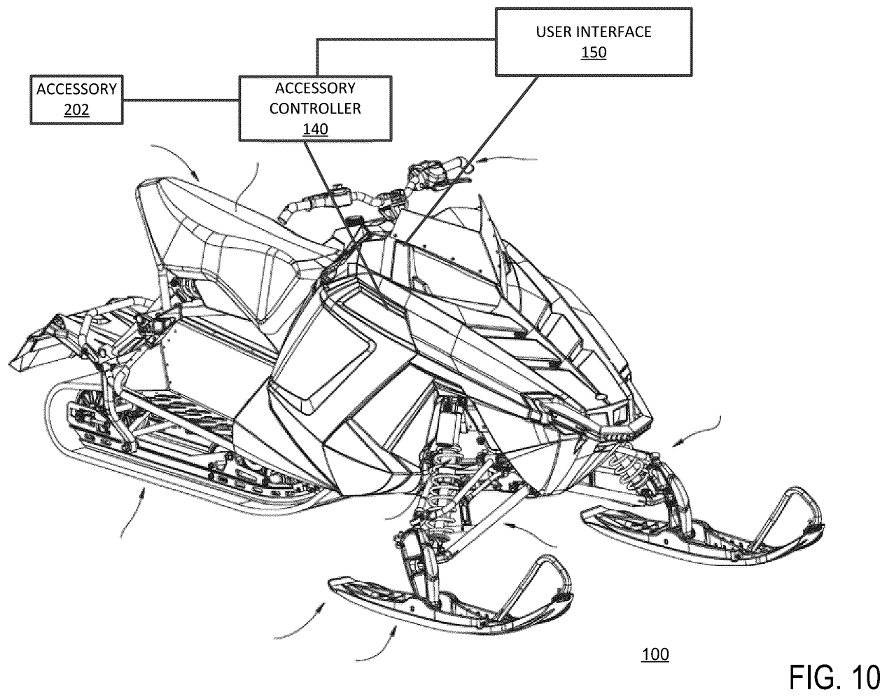

FIG. 6 illustrates a four-wheeled vehicle 100, such as a four-wheeled on-road and/or off-road vehicle. FIG. 7 illustrates an all-terrain vehicle (ATV) 100. FIG. 8 illustrates a three wheeled motorcycle type vehicle 100, such as the POLARIS SLINGSHOT. FIG. 9 illustrates a four wheel vehicle 100, such as a utility vehicle. FIG. 10 illustrates a snowmobile 100. Each of the vehicles 100 shown in FIGS. 5-10 includes one or more user interfaces 150 and accessory controller 140. Further, the accessory controller 140 maybe connected to one or more accessories. Additionally, and/or alternatively, a controller (e.g., a user interface controller 156 and/or an accessory controller 140) within the vehicles 100 shown in FIGS. 5-10 may receive, control, and/or transmit information to the accessories, such as accessories 202, 204, 206, 208. Additionally, and/or alternatively, the controller may also provide power to the accessories.

Additional details regarding the different types of the vehicle 100 shown in FIGS. 5-10 are provided in U.S. Pat. No. 8,827,019 (filed Dec. 18, 2013, titled SIDE-BY-SIDE VEHICLE), U.S. Pat. No. 9,211,924 (filed Mar. 25, 2014, titled SIDE-BY-SIDE VEHICLE), U.S. Pat. No. 8,544,587 (filed Mar. 21, 2012, titled THREE-WHEELED VEHICLE), U.S. application Ser. No. 15/387,504 (filed Dec. 21, 2016, titled TWO-WHEELED VEHICLE), U.S. Pat. No. 9,738,134 (filed Jun. 23, 2016, titled UTILITY VEHICLE), and U.S. Pat. No. 9,809,195 (filed Nov. 22, 2013, titled SNOWMOBILE), all assigned to the present assignee, the entire disclosures of which are expressly incorporated by reference herein.

FIG. 11 illustrates an example control system 300 for controlling and/or connecting one or more accessories. In some instances, the control system 300 is included within the vehicle 100 shown above (e.g., the vehicles shown in FIGS. 5-10). For example, the accessory controller 140 may communicate (e.g., receive and/or transmit information) with one or more entities (e.g., sensors 212, devices, controllers, and/or subsystems) from the vehicle 100 described above. In some examples, the sensors, devices, and/or subsystems from FIG. 11 are connected to and/or communicate with the user interface controller 156. In other words, the sensors, devices, and/or subsystems from FIG. 11 bypasses the accessory controller 140 and may directly or indirectly communicate with the user interface controller 156.

The accessory controller 140 and/or user interface controller 156 may connect to one or more accessories (e.g., accessories 202, 204, 206, 208) via a wiring harness 450 and/or a wireless connection. Further, the accessory controller 140 and/or user interface controller 156 may control operations of the accessories, such as providing commands to the accessories and/or automatically identifying the accessories.

The sensors, devices, and/or subsystems of control system 300 include, but are not limited to, the wiring harness 450, the location determiner 184, an ambient light detection sensor 316, a gear position sensor 310, an inertial measurement unit (IMU) 312, accessory power/current consumption sensor(s) 318, an engine boost level sensor 314, an electrical power supply 162 (e.g., a battery), an electrical power supply voltage sensor 308 (e.g., a battery voltage sensor), a steering sensor 306, a vehicle speed sensor 302, and/or an engine speed sensor 304. The electrical power supply 162 provides power to the accessories, such as accessory 202-208. The operation of the sensors, devices, and/or subsystems of control system 300 will be described in further detail below.

While example sensors, devices, controllers, and/or subsystems are provided in FIG. 11, additional example sensors, devices, controllers, and/or subsystems used by the accessory controller 140 and/or user interface controller 156 to control the accessories are provided in US Published Patent Application No. 2016/0059660 (filed Nov. 6, 2015, titled VEHICLE HAVING SUSPENSION WITH CONTINUOUS DAMPING CONTROL) and US Published Application No. 2018/0141543 (filed Nov. 17, 2017, titled VEHICLE HAVING ADJUSTABLE SUSPENSION), both assigned to the present assignee and the entire disclosures of each expressly incorporated by reference herein.

The illustrative control system 300 is not intended to suggest any limitation as to the scope of use or functionality of embodiments of the present disclosure. Neither should the illustrative control system 300 be interpreted as having any dependency or requirement related to any single entity or combination of entities illustrated therein. Additionally, various entities depicted in FIG. 11, in embodiments, may be integrated with various ones of the other entities depicted therein (and/or entities not illustrated). For example, the accessory controller 140 and/or user interface controller 156 may be included within the vehicle controller 218. The functionalities of the accessory controller 140, user interface controller 156, and/or other entities in control system 300 will be described below.

### Automated Accessory Actuation

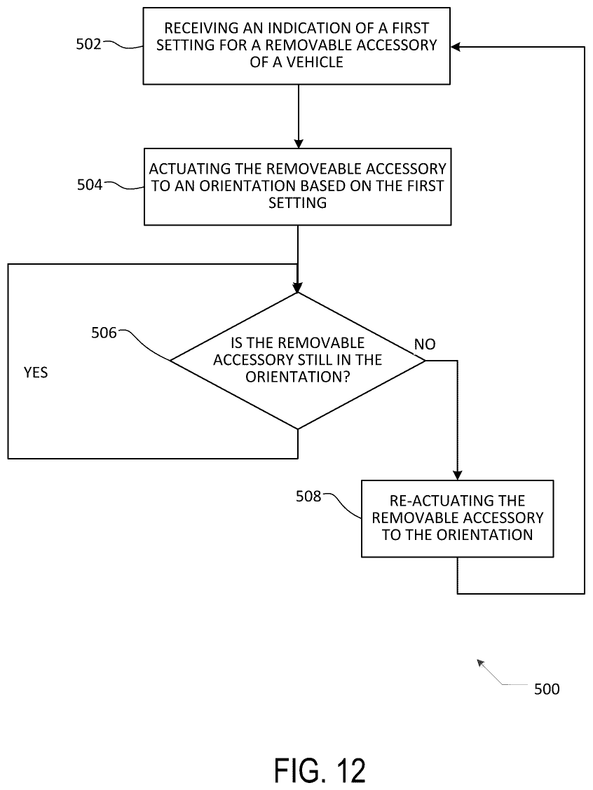

FIG. 12 illustrates an example method 500, according to some aspects described herein. In some examples, the method 500 is a method for controlling a removable accessory of a vehicle. In examples, aspects of method 500 are performed by a device, such as vehicle controller 218, accessory controller 140/802/1304, and/or user interface controller 156 described herein. Further, in some examples, aspects of the vehicle discussed with respect to method 500 may be the same or similar as aspects of the vehicle 100 discussed earlier herein with respect to FIGS. 1-10. In some examples, method 500 may be implemented via software which is downloadable to a vehicle. In some examples, method 500 may be implemented via software which is pre-installed on a vehicle.

Method 500 begins at operation 502, wherein an indication of a first setting for a removable accessory of the vehicle is received. For example, the first setting may be a height setting, an angle setting, a rotation setting, or another orientation setting. In some examples, the indication of the first setting is received via an infotainment system of the vehicle. In some examples, the indication of the first setting is received via a computing device in communication with the vehicle.

The indication of a first setting may correspond to user input specifying what the first setting should be. For example, the user input can include a selection, toggle, voice command, text input, gesture, gaze command, or any other type of user input recognized by those of ordinary skill in the art.

In some examples, the removeable accessory is a sprayer, a salt spreader, a plow, a winch, a power seat, a power window, and/or a light. Accordingly, the first setting may be a height setting of the removable accessory on the vehicle, an angle setting of the removeable accessory with respect to the vehicle, and/or another spatial orientation setting. In examples where the first setting includes an angle setting, the angle setting can be a maximum angular degree of a range of angular motion of the removeable accessory of the vehicle. In some examples, the angle setting can be a minimum angular degree of a range of angular motion of the removeable accessory of the vehicle. For instance, the angle setting can be a full-left position or a full-right position of a plow (e.g., the maximum leftward or rightward angle position in which a plow is configured to be on a vehicle with respect to a longitudinal center plane of the vehicle). In some examples, the angle setting can be a discrete value between the maximum angular degree of a range of angular motion of the removeable accessory of the vehicle and the minimum angular degree of the range of angular motion of the removeable accessory of the vehicle (e.g., a center value orthogonal to the longitudinal center plane of the vehicle). Similar functionality can be implemented with respect to other spatial orientation settings, such as a height, extension, pitch, etc.

At operation 504, the removeable accessory is actuated to an orientation based on the first setting. For example, if the first setting includes a first angle setting, then the removeable accessory is actuated to a first angle corresponding to the first angle setting. Similarly, if the first setting includes a first height setting, then the removeable accessory is actuated to a first height corresponding to the first height setting. In some examples, the actuating of the removable accessory at operation 504 includes adapting one or more actuators of the vehicle to actuate the removable accessory. In some examples, the actuators are hydraulic actuators.

At operation 506, it is determined whether the removeable accessory is still in the orientation. For example, if the removeable accessory is a plow (such as plow 206 of FIG. 4) and the plow is set to a full-left position on the vehicle, then the vehicle may hit a snow bank or other obstacle that causes the plow to move from the full-left position of the vehicle toward a longitudinal center plane of the vehicle. Accordingly, it may be desirable to automatically correct the orientation of the plow, such that it returns to the full-left position to which it was set.

In some examples, operation 506 includes determining that the removeable accessory is not still in the orientation by receiving an indication, after actuating the removable accessory to the orientation, that the removeable accessory is not in the orientation. In some examples, the indication of the removeable accessory not being in the orientation is received from a sensor. For example, the sensor can include a limit switch, a hall effect sensor, and/or a linear potentiometer. In some examples, the sensor is disposed on the vehicle and/or the removeable accessory to detect whether the removeable accessory is in the orientation associated with the first setting.

If the removeable accessory is still in the orientation, then flow branches “YES” where the method 500 can continue to check whether the removeable accessory is still in the orientation. In some examples, operation 506 can including checking at regular and/or irregular intervals of time as to whether the removeable accessory is still in the orientation. In some examples, the operation 506 includes receiving indications to determine that the removeable accessory is still in or is not in orientation. In some examples, the absence of an indication that the removeable accessory is not in the orientation indicates that the removeable accessory is in the orientation, and vice-versa.

If however the removeable accessory is not still in the orientation, flow branches “NO” to operation 508. At operation 508, the removeable accessory is re-actuated to the orientation corresponding to the first setting. For instance, going back to the plow example, if the plow is set to the full-left position, but moved out of the full-left position, then mechanisms provided herein can actuate the plow back to the full-left position to which it was set.

Method 500 may terminate at operation 508. Alternatively, method 500 may return to operation 502 to provide an iterative loop, such as of receiving an indication of a setting for a removeable accessory of a vehicle, determining whether removeable accessory is in an orientation based on the setting, and if not, reconfiguring the removable accessory to be in the orientation.

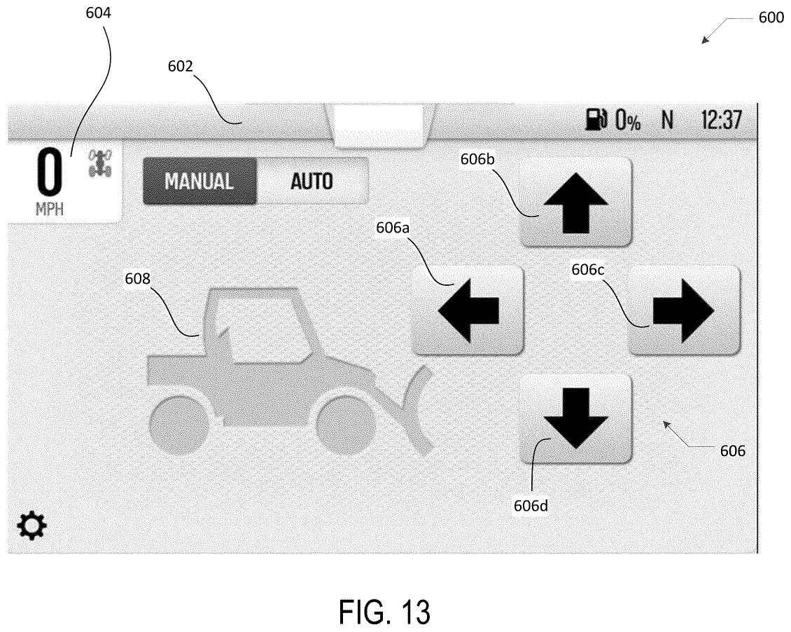

FIG. 13 illustrates an example user interface (UI) 600 according to some aspects described herein. In some examples, the user interface 600 is a graphical user interface (GUI). In some examples, the UI 600 may be displayed by a display of a computing device, such as an infotainment center of a vehicle (e.g., vehicle 100) and/or a mobile computing device (e.g., of an occupant of the vehicle), among other examples.

In some examples, the UI 600 includes a settings bar 602. In some examples, the settings bar 602 includes one or more connectivity settings of the UI 600. For example, the UI 600 (and/or vehicle associated with the UI 600) may be paired with a computing device. In some examples, the UI 600 may be connected to a computing device and/or remote server via an Ethernet connection, via a Universal Serial Bus (USB) connection, and/or via a Controller Area Network (CAN) bus, among other examples. Additionally, or alternatively, in some examples, the UI 600 is in wireless communication with the computing device and/or remote server, such as via a wireless communication network.

In some examples, the settings bar 602 includes a battery power of the vehicle, a gas level of the vehicle, a date, a time, a direction in which the vehicle is facing, and/or other information about the vehicle. In some examples, the UI 600 includes a speed display 604. For example, the speed display 604 may show a speed at which the vehicle associated with the UI 600 is travelling.

In some examples, the UI 600 includes one or more input features 606. In some examples, the input features 606 include buttons, dials, text boxes, sliders, or the like. In some examples, the input features 606 receive input from a user indicative of a setting for a removeable accessory of the vehicle. For example, a first input feature 606a can correspond to moving the removeable accessory to the left, a second input feature 606b can correspond to moving the removeable accessory upward, a third input feature 606c can correspond to moving the removeable accessory to the right, and a fourth input feature 606d can correspond to moving the removeable accessory downward. In some examples, the UI 600 can include additional input features 606, alternative input features 606, and/or feature input features 606 than those illustrated in FIG. 13.

In some examples, the UI 600 further includes a vehicle icon 608. In some examples, the vehicle icon 608 can be updated to reflect adaptions of the vehicle based on input to the input features 606.

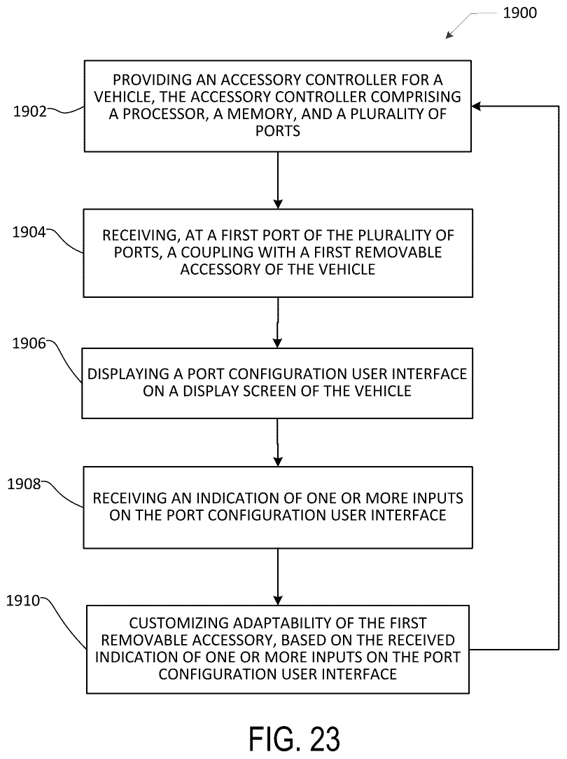

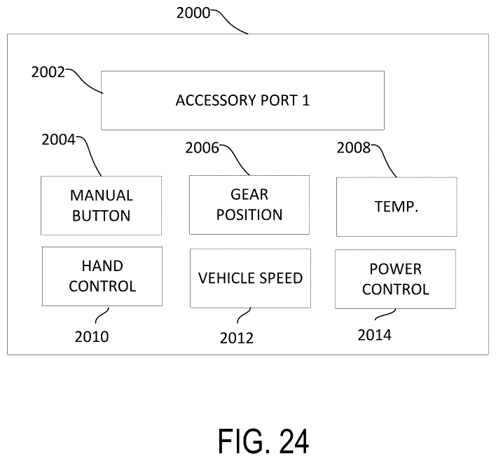

In some examples, the UI 600 can be used to manually set an orientation of a removable accessory, such as in accordance with method 500 of FIG. 5. In some examples, the UI 600 can be used to automatically set an orientation of a removable accessory, such as based on conditions of the vehicle (e.g., as discussed later herein with respect to FIGS. 23 and 24).

Interfacing with Accessories Having Heterogenous Communication Protocols

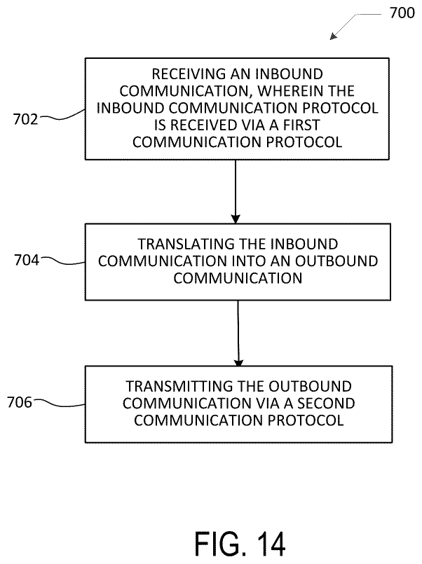

FIG. 14 illustrates an example method 700, according to some aspects described herein. In some examples, the method 700 is a method for interfacing accessories with a vehicle. In some examples, the accessories interfacing with the vehicle have heterogeneous communication protocols with respect to each other. In examples, aspects of method 700 are performed by a device, such as vehicle controller 218, accessory controller 140, 802, and/or 1304, and/or user interface controller 156 described herein. Further, in some examples, aspects of the vehicle discussed with respect to method 700 may be the same or similar as aspects of the vehicle 100 discussed earlier herein with respect to FIGS. 1-10. In some examples, method 700 may be implemented via software which is downloadable to a vehicle. In some examples, method 700 may be implemented via software which is pre-installed on a vehicle.

Method 700 begins at operation 702, wherein an inbound communication is received. For example, the inbound communication may be received via a hub or controller of the vehicle. The inbound communication is received via a first communication protocol. In some examples, the first communication protocol is one of WiFi, Cellular, Bluetooth, LoRa, J1939, or LIN. WiFi, as used herein refers to wireless fidelity as defined by the Institute of Electrical and Electronics Engineers (IEEE) standards. Cellular protocols include the set of rules and procedures that govern how mobile devices communicate with network infrastructure, such as via 2G, 3G, 4G, 5G or 6G protocols. Bluetooth, as used herein refers to the Bluetooth® standard. LoRa, as used herein, refers to long range wireless communication technology, as will be recognized by those of ordinary skill in the art. J1939, as used herein, refers to the society of automotive engineers standard J1939 protocol, as will be recognized by those of ordinary skill in the art. LIN, which stands for local interconnect network, is a serial network protocol, which can be a low-cost, low-speed network protocol for connecting sensors and actuators.

In some examples, the inbound communication is received from a first device configured to communicate via the first communication protocol. In some examples, the first device is a vehicle accessory. Examples of the first device include a clay thrower, a sprayer, a winch, a salt spreader, a gate opener, a garage door opener, a tool tracker, a trail camera, a cattle waterer, a light bar, a rain gauge, a seat heater, a wind speed sensor, a windshield wiper, an HVAC controller, an irrigation well monitor, a whip flag, a plow, and/or a long range voice (e.g., radio). In some examples, the vehicle accessory is a smart vehicle accessory, such as because the vehicle accessory has its own processor and/or memory.

At operation 704, the inbound communication is translated into an outbound communication. In some examples, one or more data packets of the inbound communication are readable in the outbound communication via a second communication protocol that is different than the first communication protocol. For example, the second communication protocol can include one of WiFi, Cellular, Bluetooth, LoRa, J1939, or LIN, while being different than the first communication protocol. In some examples, the translation into the outbound communication includes accessing a look-up table to determine what accessories are associated with what communication protocols. For example, the inbound communication may be received from a first device known to have a first communication protocol based on the look-up table, and one or more aspects of the inbound communication are to be sent to a second device that is known to have a different particular communication protocol based on the look-up table. Therefore, based on the look-up table, mechanisms provided herein can determine from which communication protocol the inbound communication is to be translated, and to which communication protocol one or more aspects of the inbound communication are to be translated.

At operation 706, the outbound communication is transmitted via a second communication protocol. For example, the outbound communication may be transmitted to a second device configured to communicate via the second communication protocol. In some examples, the second device is a vehicle accessory, such as a smart vehicle accessory with its own processor and/or memory. In some examples, the second device is a computing device, such as a server, a mobile computing device, an in-vehicle computing device, and/or a controller.

In some examples, the method 700 includes pairing with the first device, prior to receiving the inbound communication. Further, in examples, the method 700 includes pairing with the second device, prior to transmitting the outbound communication. In some examples, the pairing with the first device includes scanning a first fiducial marker (e.g., QR code, bar code, etc.) associated with the first device. Similarly, in examples, the pairing with the second device includes scanning a second fiducial marker (e.g., QR code, bar code, etc.) associated with the second device. In some examples, the pairing with the first device and/or the second device includes pairing via a radio frequency identification (RFID). For example, when an RFID tag enters the range of an RFID reader (e.g., on and/or in communication with the controller of the vehicle), a device associated with the RFID tag may be paired with the controller.

In some examples, the inbound communication includes an identifier of the first device from which the inbound communication originated. In such examples, the method 700 can further include reading the identifier from the inbound communication and pairing with the first device, by storing an indication of the identifier. For example, the indication can include an authorization credential and/or signature for the first device.

Generally, method 700 provides the ability to improve interoperability between devices with heterogeneous communication protocols. Accordingly, software developers and/or users can better interoperate between devices, using the method 700. Such improved interoperability also improves a vehicle owners experiences, as the vehicle owner can interface their vehicle with a wider array of accessories, without being limited by the accessories needing have a particular communication protocol.

While method 700 has been discussed with respect to a first device and a second device, it should be recognized that the techniques of method 700 may be applicable to any of a plurality of devices. For example, the controller of the vehicle may receive inbound communications from a plurality of devices and translate one or more of the inbound communications into one or more outbound communications.

Method 700 may terminate at operation 706. Alternatively, method 700 may return to operation 702 to provide an iterative loop, such as of receiving an inbound communication from a first device with a first communication protocol, translating the inbound communication into an outbound communication, and transmitting the outbound communication to a second device via a second communication protocol that is different than the first communication protocol.

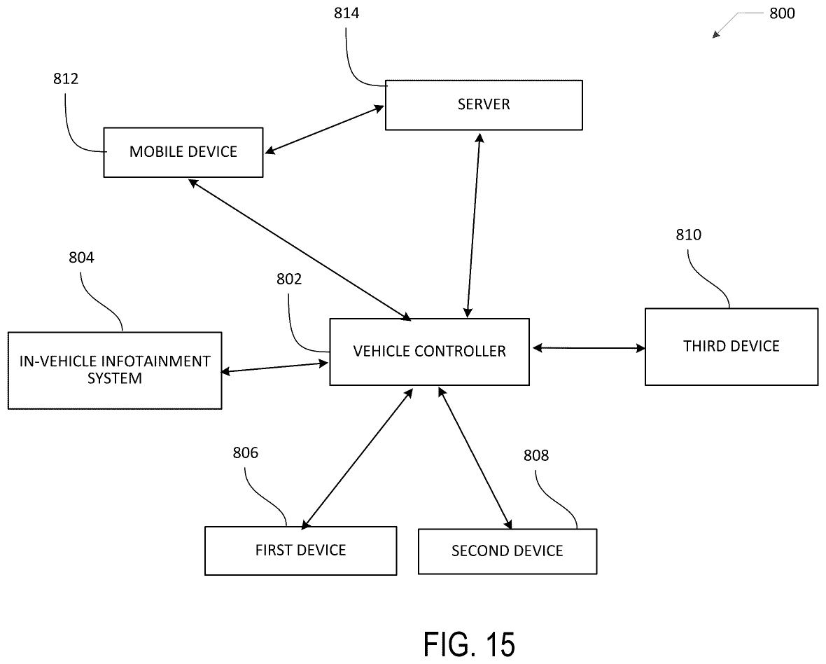

FIG. 15 illustrates an example system 800, according to some aspects described herein. In some examples, the system 800 is a system for interfacing accessories with a vehicle, such as may be used to implement method 700 discussed above. In some examples, the accessories interfacing with the vehicle have heterogeneous communication protocols with respect to each other.

The system 800 includes a vehicle hub or controller 802. In some examples, the controller 802 is the same or similar as the user interface controller 156, accessory controller 140/1304, and/or vehicle controller 218. The system 800 further includes an in-vehicle infotainment system (IVI) 804 and a plurality of devices, such as a first device 806, a second device 808, and/or a third device 810. In some examples, the system 800 further includes a mobile device 812 and/or a server 814. In some examples, the controller 802 is in communication with each of the IVI 804, first device 806, second device 808, third device 810, mobile device 812, and/or server 814. For example, the controller 802 may be in a wired connection with the IVI 804 and in a wireless connection with the first device 806, second device 808, third device 810, mobile device 812, and/or server 814.

In some examples, each of the first device 806, second device 808, third device 810, mobile device 812, and/or server 814 have a respective communication protocol with the controller 802. In some examples, the respective communication protocols include one of WiFi, Cellular, Bluetooth, LoRa, J1939, or LIN. WiFi, as used herein refers to wireless fidelity as defined by the Institute of Electrical and Electronics Engineers (IEEE) standards. Cellular protocols include the set of rules and procedures that govern how mobile devices communicate with network infrastructure, such as via 2G, 3G, 4G, 5G or 6G protocols. Bluetooth, as used herein refers to the Bluetooth® standard. LoRa, as used herein, refers to long range wireless communication technology, as will be recognized by those of ordinary skill in the art. J1939, as used herein, refers to the society of automotive engineers standard J1939 protocol, as will be recognized by those of ordinary skill in the art. LIN, which stands for local interconnect network, is a serial network protocol, which can be a low-cost, low-speed network protocol for connecting sensors and actuators.

In some examples, the vehicle controller 802 can translate commands between different devices (e.g., between two or more of the IVI system 804, the first device 806, the second device 808, the third device 810, the mobile device 812, and/or the server 814). In some examples, the vehicle controller 802 can translate commands from a first communication protocol to a second communication protocol, such that devices with different communication protocols can interface, using the vehicle controller 802. In some examples, vehicle controller 802 can generate commands according to a communication protocol for a device and/or translate commands between different communication protocols. In some examples, the vehicle controller 802 can relay translated command according to a corresponding communication protocol for a target device.

In some examples, at least one of the plurality of devices 806-810 is a smart winch that is in communication with the controller 802 via a CAN, LIN, or WiFi connection. In some examples, the controller 802 can track a speed of the winch. In some examples, the controller 802 can track and/or control a gear of the winch. In some examples, the controller 802 can track and/or control a rope speed of the winch. In some examples, the controller 802 can track and/or control a pulling force of the winch. In some examples, the controller 802 can auto-retract the winch. In some examples, the controller 802 can track a current rope position and/or a rope tension of the winch.

In some examples, at least one of the plurality of devices 806-810 is a smart sprayer in communication with the controller 802 via WiFi. In some examples, the smart sprayer can provide information to the controller 802 such as a pressure of the sprayer, a tank level, and/or a mix portion. In some examples, location positioning of the sprayer can be tracked. In some examples, when a sprayer is on/off can be tracked, and such on/off information can be paired with the location positioning of the sprayer. In some examples, flow of the sprayer can be increased/decreased by the controller 802, such as based on a ground speed of a vehicle to which the sprayer is coupled.

In some examples, at least one of the plurality of devices 806-810 is a gate opener in communication with the controller 802, such as via WiFi. In some examples, the gate opener has scheduled times for the gate to open. In some examples, the gate opener connects to the controller 802 as the controller 802 approaches the gate via a threshold proximity. In some examples, when the controller 802 approaches the proximity threshold, a notification may be displayed via the IVI 804 to prompt a user to open the gate (e.g., by providing input to the IVI 804 or another device in communication with the controller 802) or, as another example, the gate may be opened automatically.

In some examples, at least one of the plurality of devices 806-810 is a garage door opener in communication with the controller 802, such as via WiFi. In some examples, the garage door opener has scheduled times for a garage to open. In some examples, the garage door connects to the controller 802 as the controller 802 approaches the garage via a threshold proximity. In some examples, when the controller 802 approaches the threshold proximity, a notification may be displayed via the IVI 804 to prompt a user to open the garage (e.g., by providing input to the IVI 804 or another device in communication with the controller 802) or, as another example, the garage may be opened automatically.

In some examples, the controller 802 can transmit information from one or more devices of the plurality of devices 806-810 to the IVI 804, the mobile device 812, and/or the server 814. In some examples, the controller 802 can transmit information from the IVI 804, the mobile device 812, and/or the server 814 to one or more devices of the plurality of devices 806-810. For example, an software update can be transmitted from the mobile device 812, and/or the server 814 to one or more devices of the plurality of devices 806-810. As another example, a command from a user can be transmitted from the mobile device 812, and/or the server 814 to one or more devices of the plurality of devices 806-810, to adapt a state of the one or more devices of the plurality of devices 806-810 (e.g., a power state, an orientation state, etc.).

As illustrated by system 800, techniques provided herein improve interoperability between devices with heterogeneous communication protocols. Accordingly, software developers and/or users can better interoperate between devices. Such improved interoperability can improve a vehicle owners experiences, as the vehicle owner can interface their vehicle with a wider array of accessories, without being limited by the accessories needing have a particular communication protocol.

### User Input Customization for Accessories

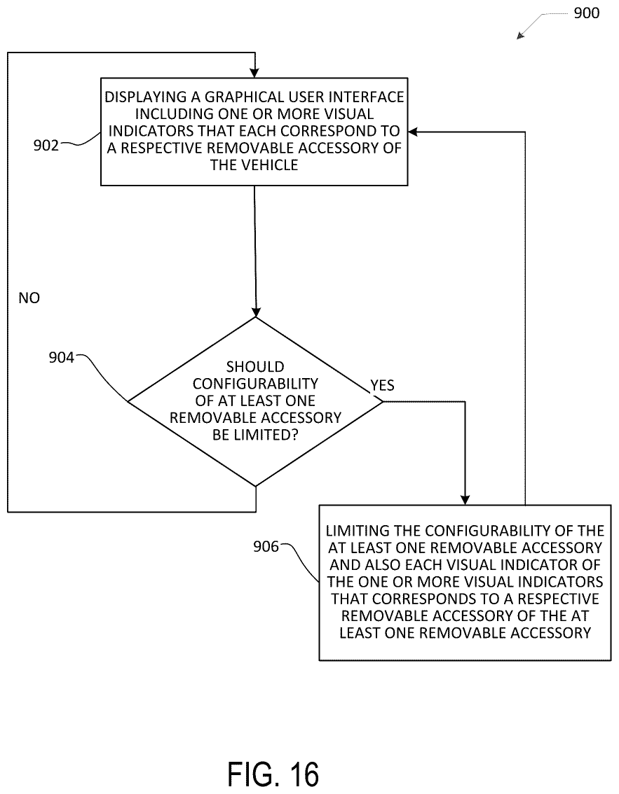

FIG. 16 illustrates an example method 900, according to some aspects described herein. In some examples, the method 900 is a method for limiting configurability of one or more accessories of a vehicle. In examples, aspects of method 900 are performed by a device, such as vehicle controller 218, accessory controller 140/802/1304, and/or user interface controller 156 described herein. Further, in some examples, aspects of the vehicle discussed with respect to method 900 may be the same or similar as aspects of the vehicle 100 discussed earlier herein with respect to FIGS. 1-10. In some examples, method 900 may be implemented via software which is downloadable to a vehicle. In some examples, method 700 may be implemented via software which is pre-installed on a vehicle.

Method 900 begins at operation 902, wherein a graphical user interface (GUI) is displayed. For example, the GUI may be displayed via an IVI of a vehicle. In some examples, the GUI may be displayed via a cellphone, wearable device, laptop, or another computing device recognized by those of ordinary skill in the art. The GUI includes one or more visual indicators. In some examples, each visual indicator of the one or more visual indicators corresponds to a respective removable accessory of the one or more removable accessories.

In some examples, the visual indications include buttons, sliders, icons, switches, text boxes, and/or another type of visual indication which may be displayed in a virtual environment. In some examples, each visual indicator is configurable, such that user input corresponding to a first visual indicator of the one or more visual indicators enables adapting a state of a respective first removeable accessory corresponding to the first visual indicator. For example, the first visual indicator may be a switch corresponding to a winch, and the switch may have an on position and an off position, which can be toggled to turn to the winch on or off. As another example, the first visual indicator may be a slider corresponding to the winch, and the slide may have a plurality of continuous and/or discrete positions which can be selected to control a speed at which the winch is wound and/or unwound.

Examples of accessory states which may be adapted by the one or more visual indicators include an on/off/standby state, a speed (e.g., for a winch), a battery usage amount, and/or a spatial orientation of an accessory. Additional and/or alternative examples of accessory states may be recognized by those of ordinary skill in the art, at least in light of the types of accessories discussed throughout the present disclosure. Examples of removeable accessories include a winch, a dump bed, a light, a wiper, a plow, and/or a sprayer. Additional and/or alternative examples of removable accessories may be recognized by those of ordinary skill in the art.

At operation 904, it is determined whether to limit configurability of at least one removeable accessory of the one or more removeable accessories. For example, it may be desirable to lock out accessory functions to ensure that a vehicle operator and/or user do not attempt to use the accessory functions during certain conditions. As another example, it may be desirable to lock out accessory functions to prevent certain users from using the accessory functions, such as due to age restrictions, training restrictions, skill restrictions, and/or vehicle owner preference.

In some examples, operation 904 includes obtaining a user profile corresponding to an operator of the vehicle. For example, an operator may provide an indication to the vehicle of their user profile (e.g., when they attempt to start the vehicle and/or after starting the vehicle). As another example, the vehicle may detect who is the operator, such as via a visual sensor, RFID sensor, Bluetooth sensor, and/or another sensor, and access a user profile associated with the operator. Based on the user profile, operation 904 may include determining that functionality of the at least one removable accessory of the one or more removable accessories should be limited. For example, the user profile may include attributes such as a training level, a safety level, an experience level, an age of the user, preferences of the user, vehicle owner preferences for the user, and/or other attributes indicating that functionality of one or more removable accessories should be limited. Therefore, in some examples, if a user is under a minimum age, based on their user profile, and/or untrained in using a particular accessory, then the accessory may be disabled for them.

In some examples, operation 904 includes evaluating a state of the vehicle. For example, the vehicle state can include a speed of the vehicle, an orientation of the vehicle, a battery level of the vehicle, a fuel level of the vehicle, and/or a weight of the vehicle. Additional and/or alternative vehicle states may be recognized by those of ordinary skill in the art. Based on the vehicle state, operation 904 may include determining that functionality of the at least one removable accessory of the one or more removable accessories should be limited. For example, if a vehicle is travelling at a relatively high speed, then the ability to use a winch may be limited at that high speed. As another example, if a vehicle is relatively low on battery, then it may be desirable to lower or turn off battery usage for one or more removeable accessories that are using the vehicle's battery.

If it is determined that configurability of at least one removeable accessory should not be limited (e.g., based on a user profile and/or vehicle state), then flow branches “NO” where method 900 may return to operation 902 and/or loop back to another determination at operation 904. However, if it is determined that configurability of at least one removeable accessory should be limited, then flow branches “YES” to operation 906. At operation 906, the configurability of the at least one removable accessory is limited. For example, a controller of the vehicle may send a signal to limit configurability of the at least one removeable accessory. As another example, the controller of the vehicle may prevent sending one or more signals, to limit configurability of the at least one removeable accessory.

In some examples, the configurability of each visual indicator that corresponds to a respective removeable accessory of the at least one removeable accessory is also limited. For example, if a visual indicator is a slider, then a user may be unable to slide the slider or be unable to slide the slider to a same degree as when the visual indicator was not limited. As another example, if a visual indicator is a two-state switch, then a user may be unable to toggle between the two states of the switch when the switch is limited. As another example, if the visual indicator is a three-state switch, then a user may be unable to toggle to one or more states of the three-state switch.

In some examples, in addition to and/or alternatively to the visual indicator configurability being limited, a physical user input corresponding to the at least one removeable accessory may also be limited. For example, signals from a button, dial, steering wheel control, handlebar control, or another physical input device may be blocked from being received by a controller and/or ignored by a controller, to limit configurability of the at least one removeable accessory.

In some examples, the limiting the configurability of the at least one removable accessory includes disabling the at least one removable accessory from changing states and also disabling each visual indicator corresponding to a respective removable accessory of the at least one removable accessory from changing states. In some examples, the limiting the configurability of the at least one removable accessory includes reducing an amount of states to which the at least one removable accessory can be configured and also reducing an amount of states to which each visual indicator corresponding to a respective removable accessory of the at least one removable accessory can be configured. For example, a removeable accessory and/or visual indicator can have three or more possible states, and the limited configurability may reduced the amount of states to instead be two or more possible states, such that a user can still toggle between some, but not all, of the possible states.

In some examples, method 900 further includes generating one or more notifications of the configurability of the at least one removable accessory being limited and displaying the one or more notifications, via the GUI. For example, a user may receive a message via the GUI indicating that the at least one removable accessory has limited configurability. In some examples, the notification includes a visual indication and/or an audio indication. In some examples, a visual indicator associated with a removeable accessory with limited functionality may have a changed color, shape, pattern, overlay, icon, or other change in visual appearance to notify to a user that the configurability of the accessory associated with the visual indicator is limited. Such a notification may be presented as a result of determining to limit accessory configurability (e.g., operation 904) and/or as a result of receiving an actuation of a corresponding visual indicator that has since been disabled and/or limited as a result of method 900, among other examples.

Method 900 may terminate at operation 906. Alternatively, method 900 may return to operation 902 and/or 904 to provide an iterative loop, such as of determining whether configurability of at least one removeable accessory should be limited, and then limiting the configurability of the at least one removeable accessory and each visual indicator on a GUI that corresponds to a respective one of the at least one removeable accessory.

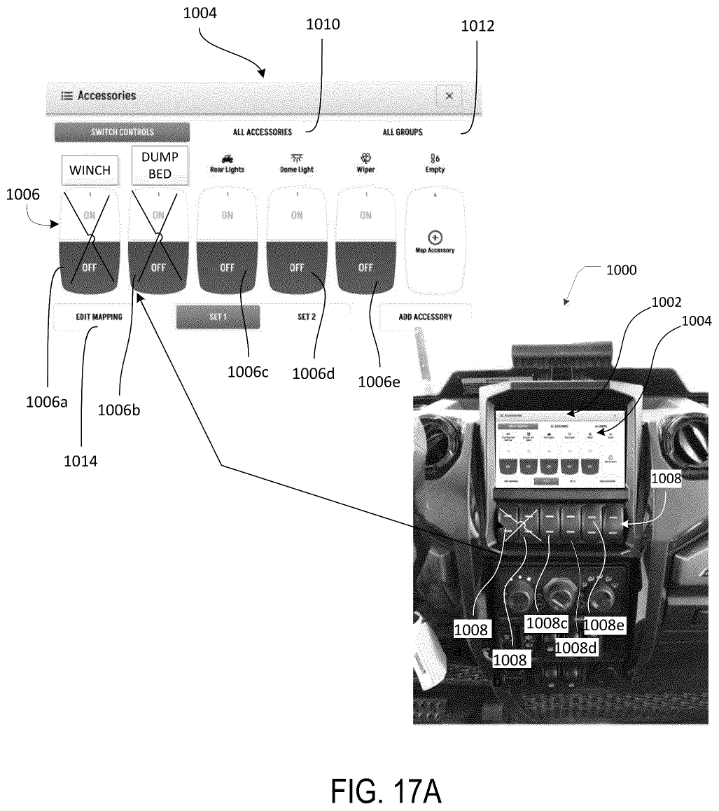

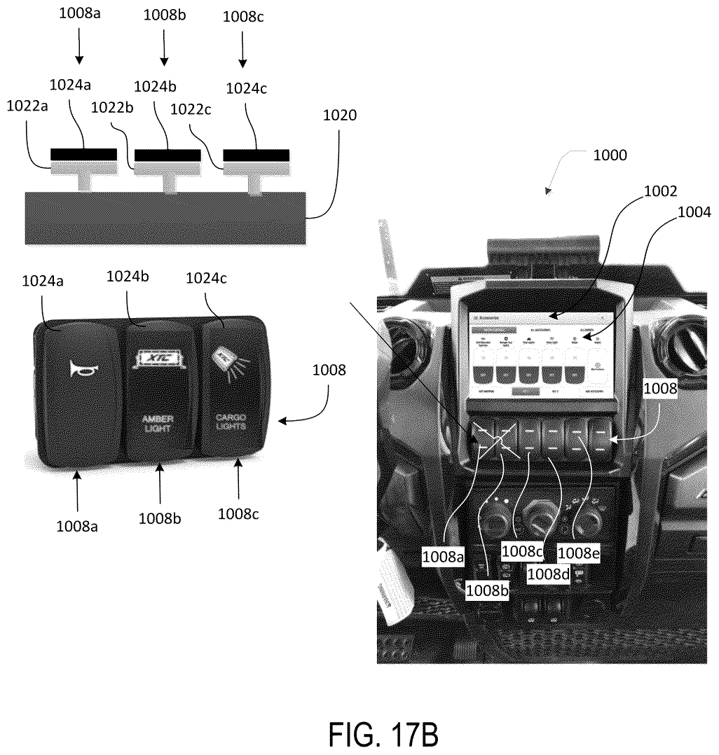

FIG. 17A illustrates an example user interface 1000 of a vehicle. In some examples, the user interface 1000 includes an in-vehicle infotainment system (IVI) on a console of the vehicle. The example user interface 1000 includes a display 1002 with a graphical user interface 1004. In examples, the display 1002 is a touchscreen display. The graphical user interface 1004 includes a plurality of visual indications 1006, including soft keys 1006a-e. In some examples, the soft keys 1006a-e include zones, buttons, sliders, and/or other interactive features displayed on the display 1002 of the user interface 1000. In some examples, the user interface 1000 includes a plurality of hard keys or user input devices 1008, including the hard keys 1008a-c. In some examples, the hard inputs include buttons, knobs, levers, joysticks, or other physically moveable components from which user input can be received.

In some examples, the graphical user interface 1004 includes a page for a digital library 1010. In some examples, the digital library 1010 corresponds to a plurality of removeable accessories which are paired to and/or compatible with the vehicle. For example, the digital library 1010 can include a list of the plurality of removable accessories, icons for each of the plurality of removable accessories, and/or other types of indications to a user describing which removable accessories are paired to and/or compatible with the vehicle.

In some examples, the graphical user interface 1004 includes a page for groups 1012 of digital accessories. For example, one or more removable accessories can be assigned to a group of removable accessories. An indication of the group of removable accessories can be stored in memory (e.g., of a controller of the vehicle). In some examples, a user can change a state of a group of removable accessories, thereby changing a state of multiple removable accessories within the group at once. For example, a group of removable accessories can include multiple types of lights on a vehicle, and the user can toggle all of the multiple types of lights on/off at once, by toggling on/off the group of removable accessories. As another example, a user may not desire to use windshield wipers without the lights also being on, because if it is raining outside then it may also be dark. Therefore, a user may toggle the wipers and lights on/off controller, if they are both in a group together.

In some examples, the graphical user interface 1004 includes a selection 1014 for editing a mapping of the visual indications 1006. For example, a user may desire for one or more of the visual indications 1006 to be updated to correspond to different removable accessories than which they currently correspond. In some examples, one or more visual indications 1006 may correspond to no removable accessories, and using the selection 1014 for editing the mapping of the visual indications 1006, a user can assign the one or more visual indications 1006 to a respective removable accessory. In some examples, each visual indication 1006 corresponds to a single removable accessory (e.g., a one-to-one mapping). In some examples, at least one of the visual indications 1006 can correspond to a plurality of removable accessories (e.g., a one-to-many mapping).

In some examples, the selection 1014 for editing a mapping of the visual indications 1006 can prompt a process for pairing an accessory to the vehicle. For example, a user can input what states of the accessory are configurable and/or the accessory can tell the vehicle which of its states are configurable, such that visual indications corresponding to the states of the paired vehicle are automatically generated.

FIG. 17B illustrates another view of the example user interface 1000, according to some embodiments of the present disclosure. In some examples, the user input devices 1008 (e.g., the hard keys 1008a-e) are coupled to a user input device bank base 1020. For example, where the user input devices 1008 are switches, the user input device bank base 1020 may be a switch bank base. In some examples, one or more of the user input devices 1008 include a respective user input device base, such as a first user input device base 1022a of the first hard key 1008a, a second user input device base 1022b of the second hard key 1008b, and a third user input device base 1022c of the third hard key 1008c. In some examples, the user input device bases 1022a-c are coupled to and protrude outward from the user input device bank base 1020. In some examples, the user input device bases 1022a-c include a magnetic element. For example, the user input device bases 1022a-c may be magnetic at a surface opposite of the user input device bank base 1020.

In some examples, one or more of the user input devices 1008 include a respective cover, such as the first cover 1024a for the first hard key 1008a, a second cover 1024b for the second hard key 1008b, and a third cover 1024c for the third hard key 1008c. In some examples, each of the covers 1024a-c include a visual indication (e.g., icon, text, color, etc.) corresponding to a respective accessory and/or state change of an accessory. For example, the visual indications on the covers 1024a-c can include an icon of a light, an icon of a light being on and/or off, an icon of a plow, an icon of a plow being raised/lowered, an icon of a sprayer, an icon a sprayer being on and/or off, and/or other types of icons that may be recognized by those of ordinary skill in the art at least in light of the teachings provided herein.

In some examples, the first cover 1024a has a visual indication that is different than the second cover 1024b and/or the third cover 1024c. In some examples, the second cover 1024b has a visual indication that is different than the first cover 1024a and/or the third cover 1024c. In some examples, the third cover 1024a has a visual indication that is different than the second cover 1024b and/or the first cover 1024a.

In some examples, the covers 1024a-c are removably coupled to the user input devices 1008, such that a user can easily switch on what user input devices 1008 the covers 1024a-c are located, depending on to what functionality the user input devices 1008 are mapped. In some examples, the covers 1024a-c include a magnetic element. For example, the covers 1024a-c can be magnetized at a surface opposite of the visual indications on the covers, such that the covers 1024a-c can be magnetically coupled to the user input device bases 1022a-c with the visual indications on the covers facing outward (e.g., to be viewable by a user). As such, in examples, a user can easily switch the magnetic covers 1024a-c between different user input devices 1008, such as by switching the magnetic covers 1024a-c between different user input device bases 1022a-c of different user input devices 1008.

In some examples, the covers 1024a-c allow for ease of placement and switching of accessory icons. With techniques provided herein, a user could leverage the covers 1024a-c to match visual indications (e.g., icons) on the covers 1024a-c with whatever custom mappings a user has programmed between their vehicle accessories, the soft keys 1006a-e, and the hard keys 1008a-c. Accordingly, the covers 1024a-c can provide visual notifications to a user of what accessory functionality is mapped to the user input devices 1008, and beneficially, allows a user to easily de-couple/re-couple the covers 1024a-c to change those visual notifications if the accessory functionality mapping is changed. In some examples, the covers 1024a-c being magnetic and with accessory decals (e.g., icons) allows a user to easily and quickly swap the locations of covers 1024a-c to provide an indication of the accessory functionality mapping associated with the user input device(s) 1008 to which the cover(s) 1024a-c are coupled.

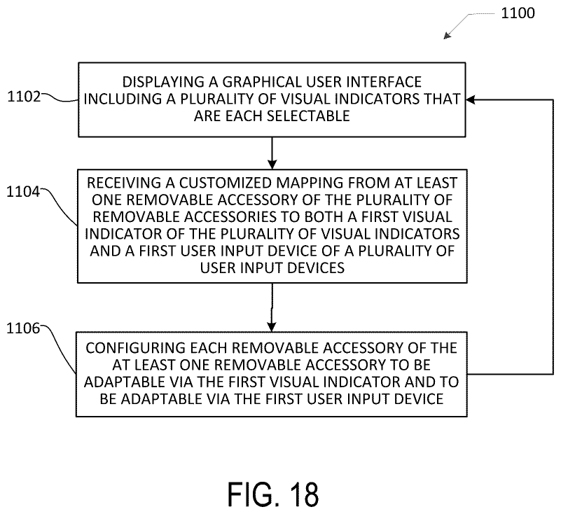

FIG. 18 illustrates an example method 1100, according to some aspects described herein. In some examples, the method 1100 is a method for mapping removable accessories of a vehicle to visual indications on a display of the vehicle. In examples, aspects of method 1100 are performed by a device, such as vehicle controller 218, accessory controller 140/802/1304, and/or user interface controller 156 described herein. Further, in some examples, aspects of the vehicle discussed with respect to method 1100 may be the same or similar as aspects of the vehicle 100 discussed earlier herein with respect to FIGS. 1-10. In some examples, method 1100 may be implemented via software which is downloadable to a vehicle. In some examples, method 1100 may be implemented via software which is pre-installed on a vehicle.

Method 1100 begins at operation 1102, wherein a graphical user interface (GUI) is displayed. For example, the GUI may be displayed via an IVI of the vehicle. In some examples, the GUI may be displayed via a cellphone, wearable device, laptop, or another computing device recognized by those of ordinary skill in the art. In some examples, the GUI is displayed via a touchscreen display, such as of the IVI of the vehicle.

The GUI includes one or more visual indicators. In examples, the one or more visual indicators are a plurality of visual indicators (e.g., visual indicators 1006 of FIG. 17A-B, including soft buttons 1006a-1006e). In some examples, each visual indicator of the plurality of visual indicators is selectable, such as via the touchscreen display.

At operation 1104, a customized mapping is received. The customized mapping is from at least one removable accessory of the plurality of removable accessories to both a first visual indicator of the plurality of visual indicators and a first user input device of a plurality of user input devices (e.g., user input devices 1008, including hard keys 1008a-e of FIG. 17A-B). In some examples, the first visual indicator is disposed to align with the first user input device (e.g., the first visual indicator may be vertically and/or horizontally in line with the first user input device).

In some examples, the customized mapping includes a mapping of only one removable accessory to only one visual indicator of the plurality of visual indicators and only one user input device of the plurality of user input devices. For instance, a removable accessory may be mapped to only one soft button and only one hard button. However, in some examples, the customized mapping includes a mapping of a plurality of removable accessories to only one visual indicator of the plurality of visual indicators and only one user input device of the plurality of user input devices. Accordingly, while some examples have a one-to-one relationship between soft/hard buttons and removable accessories, some examples have a one-to-many relationship between soft/hard buttons and removable accessories.

At operation 1106, each removable accessory of the at least one removable accessory is configured to be adaptable via the first visual indicator and to be adaptable via the first user input device. In some examples, the plurality of removable accessories includes a winch, a dump bed, a light, a wiper, and/or a sprayer. Additional and/or alternative removable accessories for a vehicle should be recognized by those of ordinary skill in the art, at least in light of the teachings described herein.

In some examples, the method 1100 further includes receiving a selection of the first visual indicator and adapting each removable accessory of the at least one removable accessory, based on the received selection of the first visual indicator. In some examples, the method 1100 further includes receiving input via the first user input device; and adapting each removable accessory of the at least one removable accessories, based on the received input via the first user input device. In other words, when a removable accessory is mapped to both a visual indicator and a user input device, the removable accessory can be adaptable via either of the visual indicator or the user input device.

In some examples, it is an advantage that by mapping a removable accessory to both a visual indicator (e.g., soft button) and a user input device (e.g., hard button), a user can select either the visual indicator or the user input device to adapt the removable accessory. For example, depending on environmental/driving conditions for a vehicle, it may be easier for a user to select the user input device than the visual indicator. In some environmental/driving conditions, it may be desirable for a user to select the visual indicator rather than the user input device.

In some examples, the customized mapping of operation 1104 is a first customized mapping, and method 1100 further includes receiving a second customized mapping from a different removable accessory than the at least one removable accessory to both the first visual indicator of the plurality of visual indicators and the first user input device of the plurality of user input devices. For example, a user may make the selection 1014 for editing a mapping of the visual indications 1006 of FIG. 17A, and input a second mapping that overwrites a previous mapping for a given visual indicator and/or user input device. In some examples, the method 1100 further includes configuring the different removable accessory to be adaptable via the first visual indicator and to be adaptable via the first user input device, such that the at least one removable accessory is no longer adaptable via the first visual indicator or the first user input device.

In some examples, method 1100 includes receiving an indication of a plurality of removable accessories being assigned a group of removable accessories (e.g., via the page for groups 1012 of accessories in FIG. 17A). For example, one or more removable accessories can be assigned to a group of removable accessories. An indication of the group of removable accessories can be stored in memory (e.g., of a controller of the vehicle). In some examples, a user can change a state of a group of removable accessories, thereby changing a state of multiple removable accessories within the group at once. For example, a group of removable accessories can include multiple types of lights on a vehicle, and the user can toggle all of the multiple types of lights on/off at once, by toggling on/off the group of removable accessories. As another example, a user may not desire to use windshield wipers without the lights also being on, because if it is raining outside then it may also be dark. Therefore, a user may toggle the wipers and lights on/off controller, if they are both assigned to a same group of removable accessories.

Method 1100 may terminate at operation 1106. Alternatively, method 1100 may return to operation 1102 and/or 1104 to provide an iterative loop for customizing mappings between soft buttons, hard buttons, and removable accessories of a vehicle.

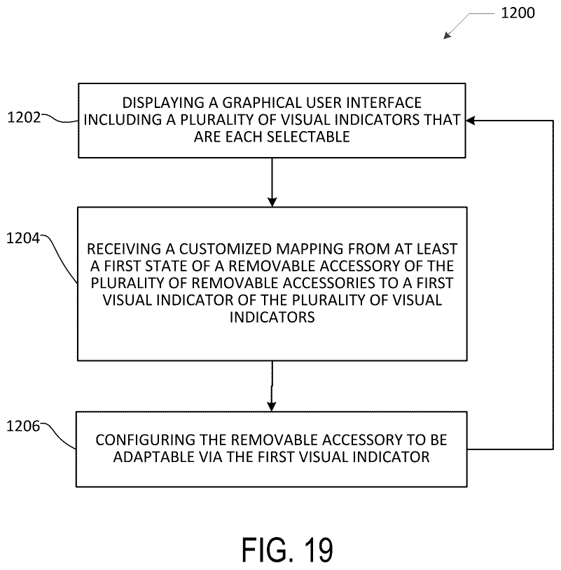

FIG. 19 illustrates an example method 1200, according to some aspects described herein. In some examples, the method 1200 is a method for mapping removable accessories of a vehicle to visual indications on a display of the vehicle. In examples, aspects of method 1200 are performed by a device, such as vehicle controller 218, accessory controller 140/802/1304, and/or user interface controller 156 described herein. Further, in some examples, aspects of the vehicle discussed with respect to method 1200 may be the same or similar as aspects of the vehicle 100 discussed earlier herein with respect to FIGS. 1-10. In some examples, method 1200 may be implemented via software which is downloadable to a vehicle. In some examples, method 1200 may be implemented via software which is pre-installed on a vehicle.

Method 1200 begins at operation 1202, wherein a graphical user interface (GUI) is displayed. For example, the GUI may be displayed via an IVI of the vehicle. In some examples, the GUI may be displayed via a cellphone, wearable device, laptop, or another computing device recognized by those of ordinary skill in the art. In some examples, the GUI is displayed via a touchscreen display, such as of the IVI of the vehicle.

The GUI includes one or more visual indicators. In examples, the one or more visual indicators are a plurality of visual indicators (e.g., visual indicators 1006 of FIG. 17A, including soft buttons 1006a-1006c). In some examples, each visual indicator of the plurality of visual indicators is selectable, such as via the display.

At operation 1204, a customized mapping is received. In some examples, the customized mapping is from at least a first state of a removeable accessory of the plurality of removeable accessories to a first visual indicator of the plurality of visual indicators. In some examples, the customized mapping further includes a mapping from at least a second state of the removeable accessory to a second visual indicator of the plurality of visual indicators.

In some examples, the customized mapping is from at least a first removeable accessory of the plurality of removeable accessories to a first visual indicator of the plurality of visual indicators and from at least a second removeable accessory of the plurality of removeable accessories to a second visual indicator of the plurality of visual indicators. In some examples, each visual indicator can correspond to a particular state change of a removable accessory. For example, a first visual indicator can correspond to a plow being raised/lowered and a second visual indicator can correspond to the plow being angled left/right. As another example, a first visual indicator can correspond to a vehicle light being on/off and a second visual indicator can correspond to a brightness setting of the light, when it is on. In some examples, a first visual indicator can correspond to a state setting of a first removable accessory and a second visual indicator can correspond to a state setting of a second removable accessory that is different than the first removable accessory.

In some examples, prior to receiving the customized mapping, a digital library is displayed corresponding to the plurality of removable accessories. The digital library may be the same or similar as the digital library page 1010 on the graphical user interface 1004. In some examples, the digital library corresponds to a plurality of removable accessories which are paired to and/or compatible with the vehicle. For example, the digital library can include a list of the plurality of removable accessories, icons for each of the plurality of removable accessories, and/or other types of indications to a user describing which removable accessories are paired to and/or compatible with the vehicle. In some examples, method 1200 includes receiving a first selection corresponding to the at least a first removable accessory, from the digital library, and a second selection corresponding to the at least a second removable accessory, from the digital library, to configure the customized mapping. In other words, removable accessories may be selected from the digital library to be used in the customized mapping to one or more of the plurality of visual indicators.

In some examples, the customized mapping is a first customized mapping that corresponds to a first user profile, and the method 1200 further includes receiving a second customized mapping that corresponds to a second user profile. In some examples, the second customized mapping is different than the first customized mapping. For example, a user may have certain preferences and/or requirements for which removable accessories and/or removable accessory states they want to control via the plurality of visual indicators. Accordingly, customized mappings may be linked to user profiles, such that different users in and/or operating a vehicle are displayed visual indicators mapped to vehicle accessories based on their user profiles.

At operation 1206, the removable accessory is configured to be adaptable via the first visual indicator. For example, the first state of the removable accessory that is mapped to the visual indicator is configured to be adaptable via the first visual indicator. In examples where the customized mapping includes a mapping from at least a first removeable accessory of the plurality of removeable accessories to the first visual indicator of the plurality of visual indicators, each removeable accessory of the at least a first removeable accessory can be configured to be adaptable via the first visual indicator. Additionally and/or alternatively, in examples where the customized mapping includes a mapping from at least a second removeable accessory of the plurality of removeable accessories to a second visual indicator of the plurality of visual indicators, at operation 1206, each removable accessory of the at least a second removable accessory can be configured to be adaptable via the second visual indicator.

In some examples, an operator seat (e.g., user support 106 of FIG. 1) defines a center plane extending along a longitudinal axis of the vehicle. For example, the center plane may symmetrically bisect the operator seat, if the operator seat is symmetrical. In some examples, the first visual indicator is disposed closer to the center plane than the second visual indicator, such that the first visual indicator is closer to the operator of the vehicle than the second visual indicator. Referring back to FIG. 17A, if the operator seat is disposed in an American car, then the first soft key 1006a may be disposed closer to the operator (and closer to the defined center plane) than the second soft key 1006b.

In some examples, the method 1200 further includes tracking a usage of the first visual indicator and the second visual indicator and determining that the second visual indicator mapped to the second removable accessory is selected more often than the first visual indicator mapped to the first removable accessory (e.g., within a predetermined period of time). In some examples, based on the determination, the second removable accessory can be updated to be mapped to the first visual indicator, instead of the first removable accessory being mapped to the first visual indicator. Accordingly, functionality that is used more often by a user can be mapped to visual indicators that are closer to the user (e.g., can be mapped to the first key 1006a, which may be closer to a vehicle operator).

Generally, method 1200 provides a beneficial abstraction layer for mapping accessory functionality to vehicle controls. For example, according to embodiments of the present disclosure, a switch bank's CAN capabilities can eliminate the need for routing a new input device (e.g., switch) through the dash of a vehicle for every new accessory that is used with the vehicle. Rather, in some examples, the new accessory can have communications routed through the CAN to digitally map the new accessory's functionality to a user interface in the vehicle. In some examples, the visual indicators have momentary capabilities that allows the visual indicators to be used for more than just on and off states. In some examples, the visual indicators also improve an operator's experience and control over vehicle accessories by providing the operator with digital feedback of accessory controls through a user interface, such as an IVI, LEDs, and/or other components of a user interface.

### Accessory Controller

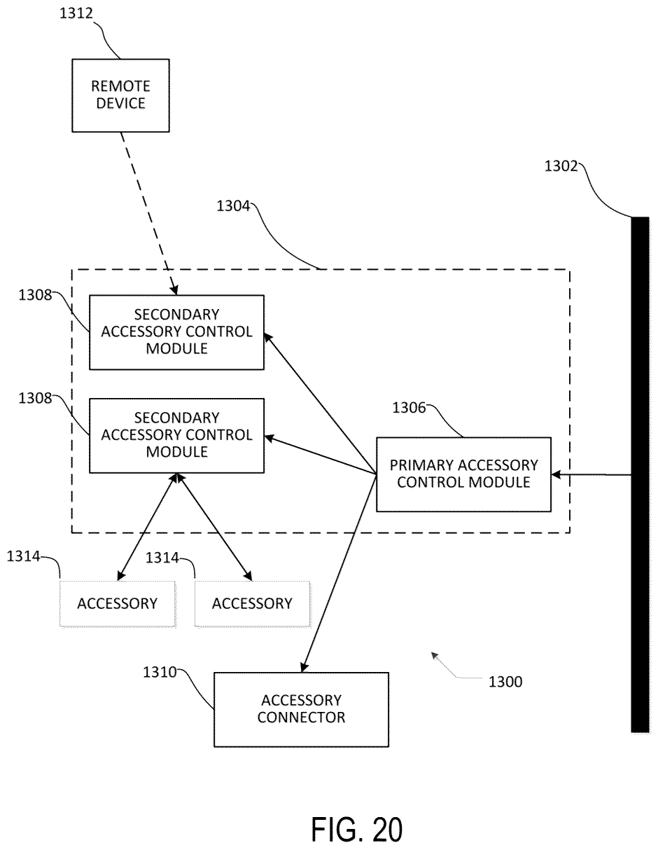

FIG. 20 illustrates an example system 1300 according to some embodiments of the present disclosure. In examples, the system 1300 can be part of a vehicle, such as the vehicle 100 described earlier herein. The system 1300 includes a controller area network (CAN) bus 1302 and an accessory controller 1304. In examples, the CAN bus may be part of the network components 182 described earlier herein. In some examples, the accessory controller 1304 includes a primary accessory control module 1306 and one or more secondary accessory control modules 1308. In some examples, the system 1300 further includes an accessory connector 1310.

In some examples, the accessory controller 1304 is in communication with the CAN bus 1302, such as via a wired and/or wireless connection. In some examples, the primary accessory control module 1306 is in communication with the CAN bus 1302, such as via a wired and/or wireless connection. In some examples, the accessory controller 1304 includes one or more processors and memories. For example, the primary accessory control module 1306 and/or the secondary accessory control module 1308 may each have their own respective processors and memories.

In some examples, a plurality of removable accessories are operatively coupled to the accessory controller 1304. For example, the plurality of removable accessories may be plugged in to ports of the accessory controller, to receive power and instructions from the accessory controller. In some examples, the accessory controller 1304 is configured to receive one or more communications from the CAN bus 1302 to adapt at least one of the plurality of removable accessories. For example, the CAN bus 1302 may receive instructions from the user interface 1004 of FIG. 17A-B indicative of a state of a removeable accessory being adapted. Such instructions from the user interface 1004 may be transmitted from the CAN bus to the accessory controller 1304, to cause the state of the removable accessory to be adapted, as instructed.

In examples, the primary accessory control module 1306 includes its own processor and memory. Further, the primary accessory control module 1306 can include digital fusing. In examples, one or more of the secondary accessory control modules 1308 include their own respective processors and memories. The secondary accessory control modules 1308 are in communication with the primary accessory control module 1306. In some examples, the secondary accessory control modules 1308 are in communication with the CAN bus 1302, via the primary accessory control module 1306.

In some examples, the primary accessory control module 1306 may be in a primary and/or controlling relationship with the secondary control modules 1308, as will be understood by those of ordinary skill in the art. Accordingly, the secondary control modules 1308 may be in a secondary and/or controlled relationship with the primary control module 1306, as will be understood by those of ordinary skill in the art. In some examples, having the primary accessory control module 1306 separate from the secondary accessory control module 1308 allows for expandability and scalability, by allowing relatively more removable accessories to couple to the accessory controller 1304, when additional secondary accessory control modules 1308 are coupled to the primary accessory control module 1306.

In some examples, the removable accessories are operatively coupled to one or more of the secondary accessory control modules 1308. In some examples, the secondary accessory control modules 1308 include ports into which the removable accessories can be physically coupled. In examples, the secondary accessory control modules 1308 are capable of providing power and data instructions to the removable accessories coupled with the secondary accessory control modules 1308.

In some examples, the primary accessory control module 1306 is configured to receive one or more communications from the CAN bus 1302, to instruct one or more of the secondary accessory control modules 1308 to adapt one or more removable accessories coupled to the secondary accessory control modules 1308.

In some examples, contrary to the primary accessory control module 1306 and the secondary accessory control module 1308, the accessory connector 1310 does not have its own processor or memory. In some examples, the accessory connector 1310 has ports to couple with removable accessories. However, in some examples, the accessory connector 1310 can only provide power to the removable accessories to which it is coupled, and cannot provide data instructions because the accessory connector 1310 does not have a processor or memory.

In some examples, the system 1300 further includes a battery. For example, the battery can be a vehicle battery, such as discussed earlier herein with respect to the electrical power supply 162 of FIG. 1. In some examples, the CAN bus 1302, the primary accessory control module 1306, and the secondary accessory control modules 1308 are all powered by the battery. Therefore, the CAN bus 1302, the primary accessory control module 1306, and the secondary accessory control modules 1308 may all be physically coupled together and to a vehicle of which the battery is included.

In some examples, the secondary accessory control modules 1308 can be daisy chained together. For example, the secondary accessory control modules 1308 can be coupled together in series and/or in a sequence. Daisy chaining can be beneficial for power distribution, data transfers, and/or signal routing. For example, a first secondary accessory control module 1308 can be operatively coupled to a second accessory control module 1308, such that the output of the first secondary accessory control module 1308 is the input for the second secondary accessory control module 1308. For power distribution, daisy chaining can allow power to be supplied to each of the secondary accessory control modules 1308 from a single source. For signal routing, daisy chaining allows for signals to be routed from one secondary accessory control module 1308 to another.

In some examples, the accessory controller 1304 includes a wireless communication module. More specifically, in some examples, the primary accessory control module 1306 and/or the secondary accessory control module 1308 include a wireless communication module. For example, the wireless communication module can be configured to communication with a remote device, such as via cellular, Bluetooth, WiFi, and/or another wireless communication protocol that may be recognized by those of ordinary skill in the art, based at least on the teachings provided herein.

In some examples, the accessory controller 1304 is configured to receive, wirelessly from a remote device 1312, one or more signals for adapting one or more removable accessories coupled to the accessory controller 1304. Further, the accessory controller 1304 can be configured to cause that one or more removable accessories to be adapted, based on the one or more received signals. For example, a user may provide input to a mobile phone, wearable device, web portal, and/or another type of remote device. The input can be indicative of changing a state of a removable accessory. The remote system may send a signal to the accessory controller 1304, and the accessory controller 1304 can cause the state change to be executed. Specifically, in some examples, the remote system sends the signal to the secondary accessory control module 1308 to cause the state change to be executed.

Examples of removable accessories include a camera, a winch, a dump bed, a light, a plow, a sprayer, and/or a wiper. Examples of state changes for a removable accessory include: turning on a light, turning off a light, dimming a light, adjusting a plow angle, increasing the spray rate of a sprayer, decreasing the spray rate of a sprayer, unraveling a winch, and/or raveling a winch. Additional and/or alternative examples of state changes for a removable accessory that can be wireless communicated to the accessory controller to execute the state change may be recognized by those of ordinary skill in the art.

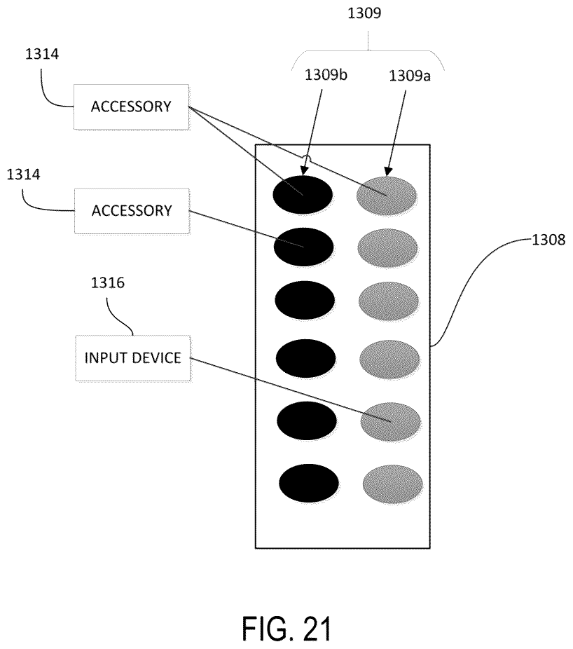

FIG. 21 illustrates a detailed schematic of the secondary accessory control module 1308. In examples, aspects discussed with respect to the secondary accessory control module 1308 may be similarly implemented in the primary accessory control module 1306 and/or the accessory controller 1304 (e.g., without two separate accessory control modules). The secondary accessory control module 1308 include a plurality of ports 1309. The plurality of ports 1309 include a plurality of CAN ports 1309a and a plurality of power ports 1309b. In some examples, a removable accessory 1314 can be coupled to both a CAN port 1309a and a power port 1309b on the secondary accessory control module 1308, such as when it is desired for the removable accessory 1314 to receive power and send/receive data communications to/from the vehicle. In some examples, the removable accessory 1314 can be coupled to only the power port 1309b, such as when the removable accessory needs power (e.g., and does not need or is unable to communicate with the vehicle via a CAN).

In some examples, one or more input devices 1316 can be coupled to the secondary accessory control module 1308, such as via the CAN ports 1309a. In examples, the one or more input device 1316 are configured to transmit one or more communications, via the secondary accessory control module 1308, to adapt one or more removable accessories. Examples of the input devices 1316 include a switch, a button, a joystick, and/or a dial. Additional and/or alternative examples of input devices should be recognized by those of ordinary skill in the art.

In some examples, the secondary accessory control module 1308 functions as a CAN bridge that allows input device 1316 with CAN communication only to interface with the secondary accessory control module 1308. In some examples, the input devices 1316 are different than the removable accessories 1314. In some examples, the input device 1316 may be the same as the removable accessories 1314, such as when a removable accessory is a switch or another type of removable accessory that includes a switch capable of providing communications via the CAN port.

In some examples, the removable accessory 1314 includes a smart light bar that is coupled to both the power port 1309a and the CAN port 1309b. However, in some examples, the removable accessory 1314 includes a standard light bar coupled to only the power port 1309a because the standard light bar only requires power (i.e., not CAN communication). It will be appreciated that similar aspects may be used for a device having wireless control, such that power is provided via a power port 1309a and control is established wirelessly. In some examples, the input device 1316 includes a CAN joystick that is coupled to the CAN port 1309b, but not the power port 1309a. In some examples, a user can provide input to the CAN joystick, to control a state of one or more of the removable accessories 1314.

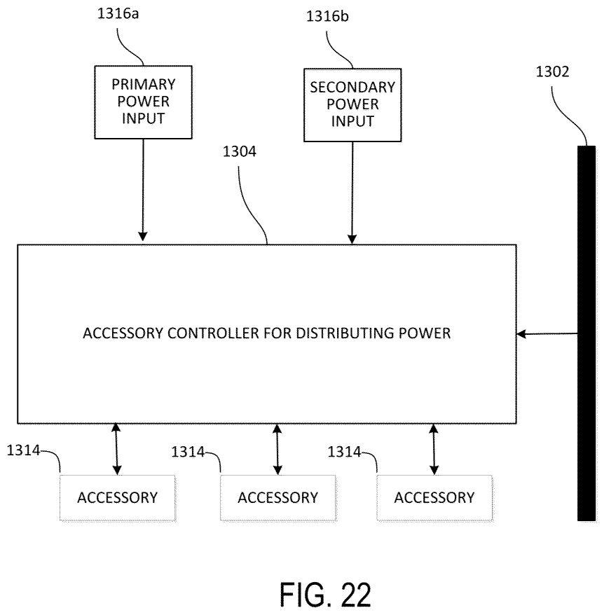

FIG. 22 illustrates another view of the example system 1300 of FIG. 20. In FIG. 22, the accessory controller 1304 is used for distributing power, such that the accessory controller 1304 is acting as a power distribution module. For example, the accessory controller 1304 can be coupled to two or more input devices 1316. For example, the input devices can include a primary power input 1316a and a secondary power input 1316b. In examples, the primary power input 1316a is a vehicle battery, such as the electrical power supply 162 of FIG. 1. In examples, the primary power input 1316a is an alternator. In examples, the secondary power input 1316b is an auxiliary battery or power source. For examples, the secondary power input 1316b can include a portable battery and/or a charger.

In examples, the accessory controller 1304 includes both electrical power and data communication capabilities. In some examples, accessory controller 1304 integrates into primary vehicle communications (e.g., the CAN bus 1302) to control power from in vehicle controls and/or remote controls. In some examples, the secondary power input 1316b allows for powering of the removable accessories 1314, even when the vehicle is in off state. In some examples, the secondary power input 1316b is configured to power one or more of the removable accessories 1314, independent of the primary power input 1316a. In some examples, the secondary power input 1316b allows for providing additive power while the vehicle is in operation (e.g., additive to the primary power input 1316a, which may be primarily relied on when the vehicle is in operation). Accordingly, the secondary power input 1316b can be configured to power one or more of the removable accessories 1314 via the accessory controller 1304.

FIG. 23 illustrates an example method 1900, according to some aspects described herein. In some examples, the method 1900 is a method for configuring an accessory controller for a vehicle. In examples, aspects of method 1900 are performed by a device, such as vehicle controller 218, accessory controller 140/802/1304, and/or user interface controller 156 described herein. Further, in some examples, aspects of the vehicle discussed with respect to method 1900 may be the same or similar as aspects of the vehicle 100 discussed earlier herein with respect to FIGS. 1-10. In some examples, method 1900 may be implemented via software which is downloadable to a vehicle. In some examples, method 1900 may be implemented via software which is pre-installed on a vehicle.

Method 1900 begins at operation 1902, wherein an accessory controller for a vehicle is provided. In examples, the accessory controller may be similar to or the same as the accessory controller 140, 802, and/or 1304 described earlier herein. In examples, the accessory controller can be similar to or the same as the primary accessory control module 1306 and/or the secondary accessory control module 1308 of the accessory controller 1304. In examples, the accessory controller includes a processor, a memory, and a plurality of ports (e.g., the ports 1309 shown in FIG. 21). In some examples, each port of the plurality of ports are sized and shaped to receive a respective coupling with a removable accessory of the vehicle. For example, each port can receive a respective plug/connector/coupling from a respective removable accessory (e.g., the removable accessories 1314 of FIG. 21).

At operation 1904, a coupling (e.g., plug/connector) with a first removable accessory of the vehicle is received at a first port of the plurality of ports. In some examples, the plurality of ports includes two ports, four ports, six ports, or cight ports. Additional and/or alternative numbers of ports (e.g., an odd number of ports) that may exist on the accessory controller may be recognized by those of ordinary skill in the art.

At operation 1906, a port configuration user interface is displayed on a display screen of the vehicle. For example, the port configuration user interface can include a graphical user interface (GUI). The GUI may be displayed via an IVI of the vehicle. In some examples, the GUI is displayed via a touchscreen display, such as of the IVI of the vehicle. An example port configuration user interface 2000 is illustrated in FIG. 24.

The example port configuration user interface 2000 includes a plurality of visual indications, including a first visual indication 2002, a second visual indication 2004, a third visual indication 2006, a fourth visual indication 2008, a fifth visual indication 2010, a sixth visual indication 2012, and a seventh visual indication 2014. In some examples, the visual indications 2002-2014 include text, icons, colors, shapes, and/or other visual characteristics that may be recognized by those of ordinary skill in the art. In some examples, the visual indications 2002-2014 are selectable, rotatable, or otherwise capable of being adapted based on user input, such as based on user input provided to the display on which the visual indications 2002-2014 are displayed.

In some examples, the first visual indication 2002 is selectable to choose which accessory port of a plurality of accessory ports a user is configuring. For example, the first visual indication 2002 can include an indication of a first accessory port, a second accessory port, and/or another accessory port of the plurality of accessory ports on the accessory controller. In some examples, the first visual indication 2002 can be adapted (e.g., selected) to choose which removable accessory a user desires to configure. For example, the port configuration user interface 2000 may be preloaded with types of removable accessories for a user to select to configure. Example removable accessories include a radio, a light bar, a work light, a spot light, a winch, a sprayer, a windshield wiper, a fan, and/or a plow. Additional and/or alternative examples of removable accessories should be recognized by those of ordinary skill in the art.

At operation 1908, an indication of one or more inputs on the port configuration interface are received. In some examples, the port configuration user interface 2000 can be preloaded with different functions available for a user to select. In some examples, each of the functions can correspond to a respective visual indication of the plurality of visual indications 2004-2014. Examples of functions available for a user to select include a manual input, a vehicle gear position, a temperature (e.g., of the vehicle, battery, engine, environment), a hand control, and/or a vehicle speed. Additional and/or alternative functions available for a user to adapt for configuring an accessory controller should be recognized by those of ordinary skill in the art.

At operation 1910, adaptability of the first removable accessory is customized, based on the received indication of one or more inputs on the port configuration user interface. In some examples, the method 1900 further includes detecting an occurrence of one or more conditions of the vehicles corresponding to the received indication of one or more inputs on the port configuration user interface and adapting the first removable accessory based on the detection. In some examples, an advantage of method 1900 is that power to each port can be controlled using a control signal from the vehicle display via CAN, discrete I/O, and/or other electrical communication methods. This advantageous degree of control allows for vehicle owners/occupants to have enhanced control over the use of their vehicle accessories.

In some examples, the second visual indication 2004 corresponds to a manual control, such as for when a user wants to change one or more states of a removable accessory manually. In some examples, the manual control includes setting a condition for the one or more states to be changed, when the condition is not otherwise specified by another of the visual indications 2006-2014. Accordingly, based on one or more inputs to the second visual indication 2004 (e.g., the manual control), one or more states of the first removable accessory can be adapted.

In some examples, the third visual indication 2006 corresponds to a gear position. For example, the third visual indication 2006 can receive input from a user to configure one or more states of a removable accessory, based on a condition associated with a gear position of the vehicle (e.g., a gear position of the transmission 116 of FIG. 2). For example, a removable accessory can be turned on/off depending on the gear position of the transmission (e.g., a first gear, second gear, third gear, reverse gear, etc.). In some examples, the removable accessory (e.g., specified by the first visual indication 2002) can be automatically adapted based on the gear position, when a user configures such settings, for example via the third visual indication 2006.

In some examples, the fourth visual indication 2008 corresponds to a temperature (e.g., of the vehicle, a battery of the vehicle, an engine of the vehicle, an environment surrounding the vehicle, an accessory, etc.). For example, the third visual indication 2006 can receive input from a user to configure one or more states of a removable accessory, based on a condition associated with the temperature. For example, a removable accessory can be turned on/off depending on the temperature, such that if the temperature is greater than a threshold, the removable accessory turns off. As another example, a power/speed settings of the removable accessory can be increased/reduced based on the temperature. In some examples, the removable accessory (e.g., specified by the first visual indication 2002) can be automatically adapted based on the temperature, when a user configures such settings, for example via the fourth visual indication 2008.

In some examples, the fifth visual indication 2010 corresponds to a hand control. For example, the third visual indication 2006 can receive input from a user to configure one or more states of a removable accessory, based on a condition associated with the hand control. Examples of hand controls can be positioning of a steering wheel, gestures provided to a sensor, positioning of handlebars, and/or movement of a button, knob, joystick, etc. For example, a removable accessory can be turned on/off depending on the hand control, such that if the hand control is detected, the removable accessory can be turned on/off. As another example, a power/speed settings of the removable accessory can be increased/reduced based on the hand control. In some examples, the removable accessory (e.g., specified by the first visual indication 2002) can be automatically adapted based on the hand control, when a user configures such settings, for example via the fifth visual indication 2010.

In some examples, the sixth visual indication 2012 corresponds to a vehicle speed. For example, the sixth visual indication 2012 can receive input from a user to configure one or more states of a removable accessory, based on a condition associated with the vehicle speed. Examples of vehicle speed settings can include detecting when the vehicle is above and/or below one or more speed thresholds. For example, a removable accessory can be turned off if a vehicle is at a relatively high speed (e.g., above a particular speed threshold, such as 20 miles per hour). As another example, a power/speed settings of the removable accessory can be increased/reduced based on the vehicle speed. In some examples, the removable accessory (e.g., specified by the first visual indication 2002) can be automatically adapted based on the vehicle speed, when a user configures such settings, for example via the sixth visual indication 2012.

In some examples, the seventh visual indication 2014 corresponds to a power control (e.g., a battery level and/or battery usage, such as of the vehicle and/or one or more removable accessories). For example, the seventh visual indication 2014 can receive input from a user to configure one or more states of a removable accessory, based on the power control. For example, a removable accessory can be turned off if a vehicle is at a relatively low battery level. As another example, a power/speed settings of the removable accessory can be increased/reduced based on the power control. Such controllability can be advantageous to prevent battery damage and/or low voltage. In some examples, the removable accessory (e.g., specified by the first visual indication 2002) can be automatically adapted based on the power control, when a user configures such settings, for example via the seventh visual indication 2014.

Additional and/or alternative visual indications and corresponding trigger controls may be recognized by those of ordinary skill in the art. As such, embodiments of the present disclosure should not be limited to the particular trigger controls described herein (e.g., the manual button, gear position, temperature, hand control, vehicle speed, and/or power control).

Method 1900 may terminate at operation 1910. Alternatively, method 1900 may return to operation 1902 and/or another operation of method 1900 to provide an iterative loop for configuring an accessory controller for a vehicle.

### Intelligent Plowing

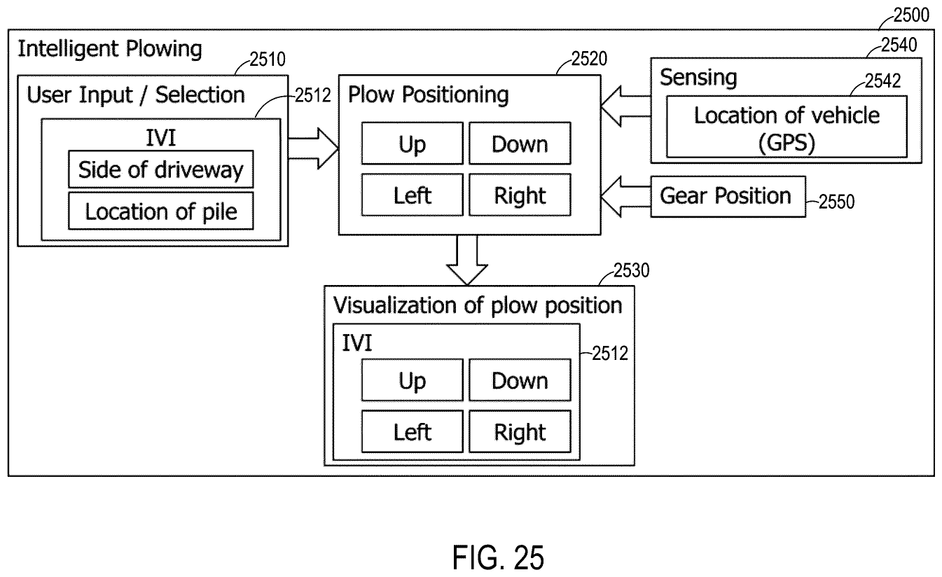

Referring to FIG. 25, an example intelligent plowing system 2500 is illustrated, according to some embodiments of the present disclosure. The system 2500 includes a plow mounted to a recreational vehicle, with plow position 2520 and angle being automatically controlled in response to operator input 2510. The operator input 2510 may specify a desired plowing outcome, such as a predetermined location or direction for plowed material, and may include selections for standard plowing or backplowing modes. As described herein, the system 2500 controls the plow in an automatic manner to achieve the specified plowing outcome.

The system utilizes gear position data 2550, as well as information from one or more sensors 2540, such as a location sensor 2542 and/or a direction sensor (not shown), to determine the required plow position and angle to achieve the operator's specified outcome. The plow is actuated accordingly, and as the vehicle moves, the system continuously updates the relevant data and adjusts the plow position 2520 and angle in real time to ensure that plowed material is directed toward the specified location or direction.

A visualization of plow position 2530 is provided, which may be displayed on the in-vehicle infotainment (IVI) system 2512. This visualization offers a visual indication of the current plow position and the direction in which material is being pushed, enabling the operator to monitor and confirm the plowing operation. The intelligent plowing system 2500 illustrated in FIG. 25 supports various permutations, including standard plowing, backplowing, and dynamic redirection of material, thereby reducing the need for manual plow adjustments and enhancing the efficiency and user experience of plowing operations. Instead, the intelligent plowing system 2500 frees the operator to conduct driving operations of the recreational vehicle while the system 2500 handles control of the plow based on the specified plowing outcome.

### Wireless Smart Accessory Ecosystem

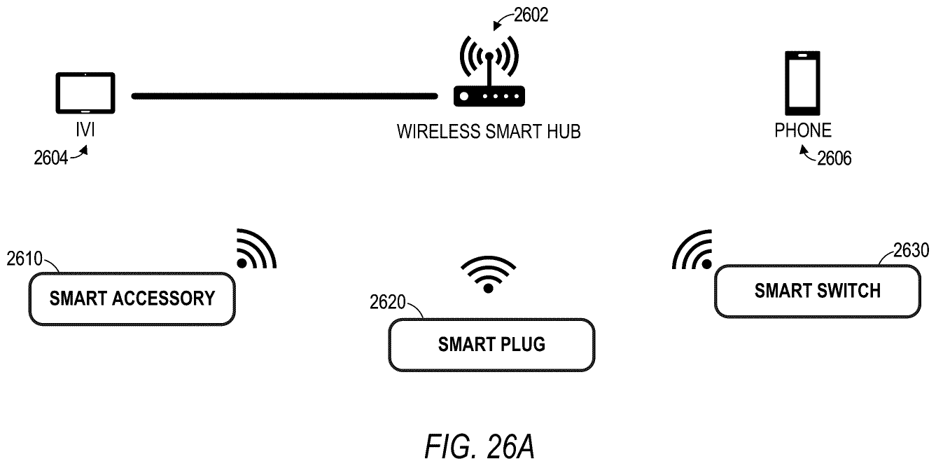

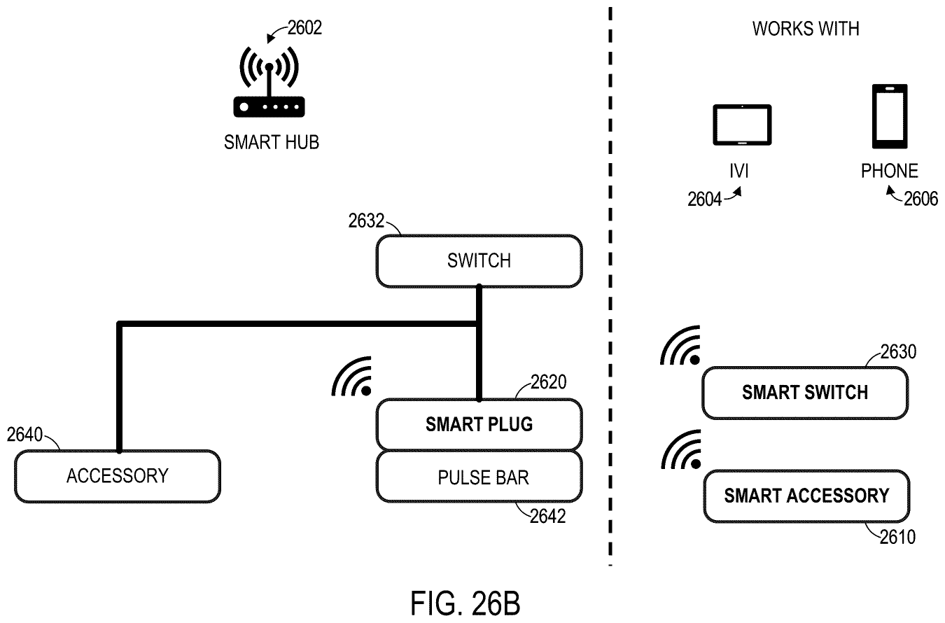

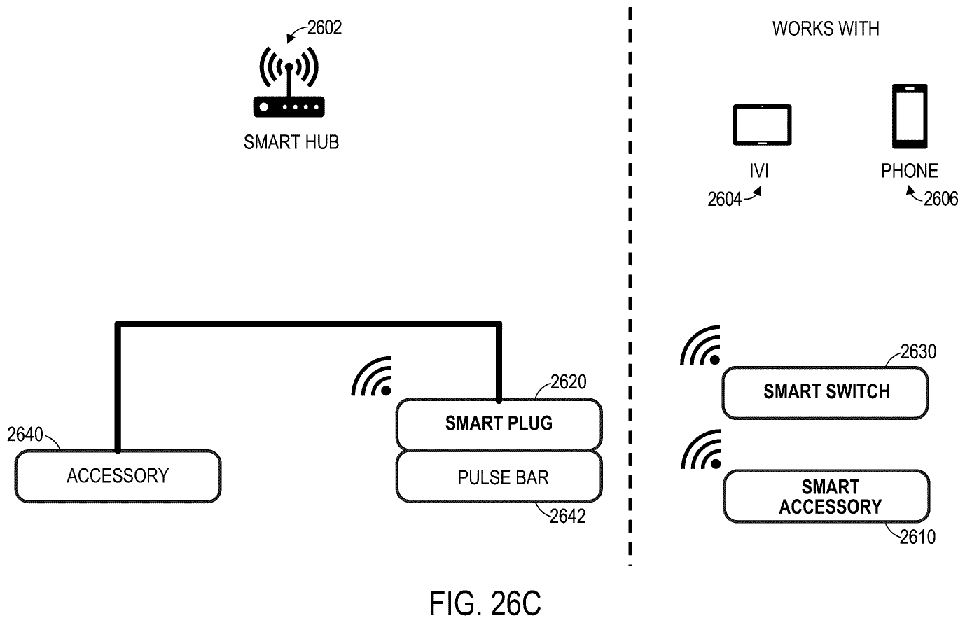

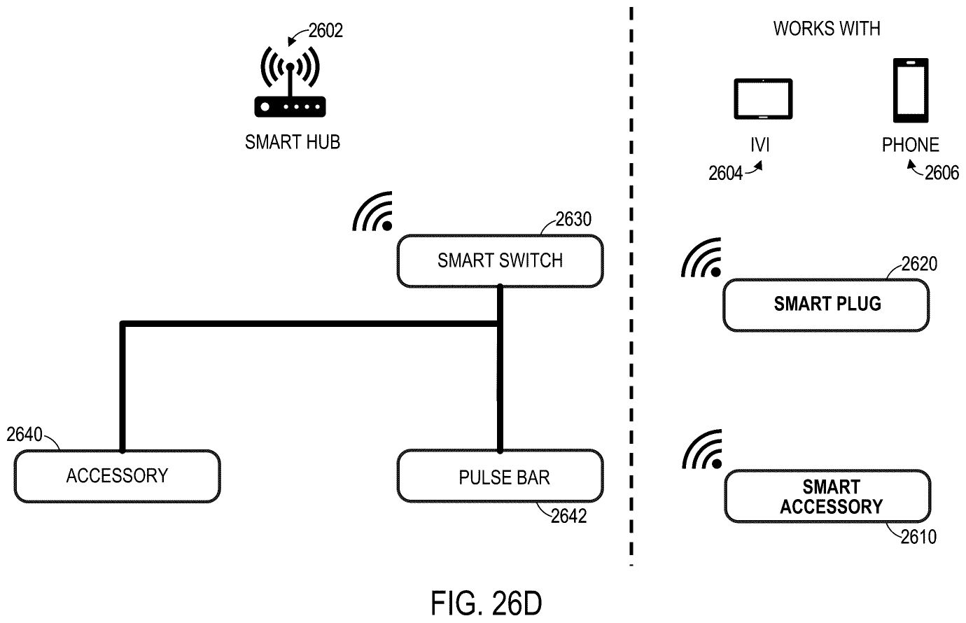

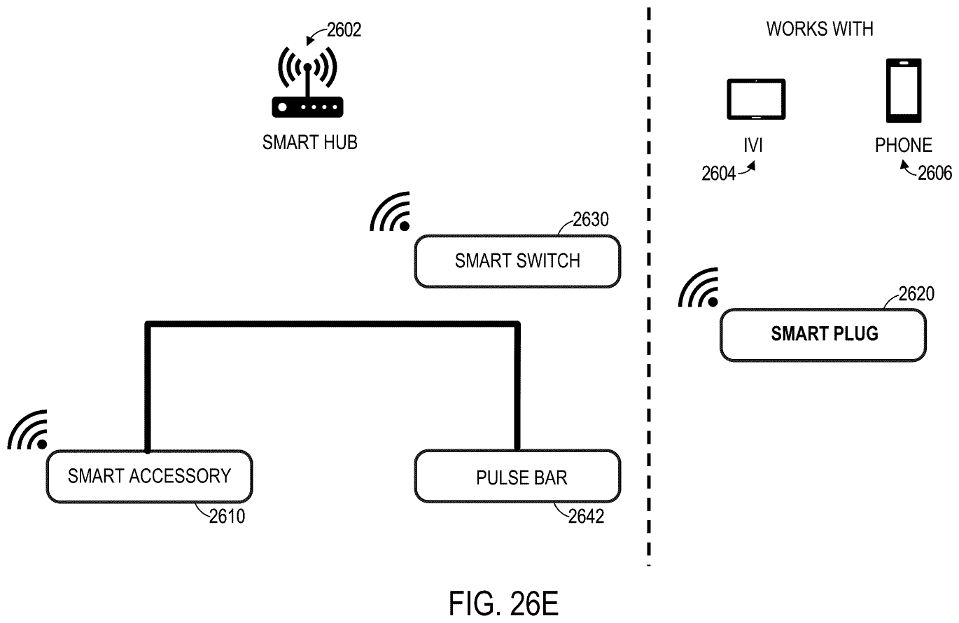

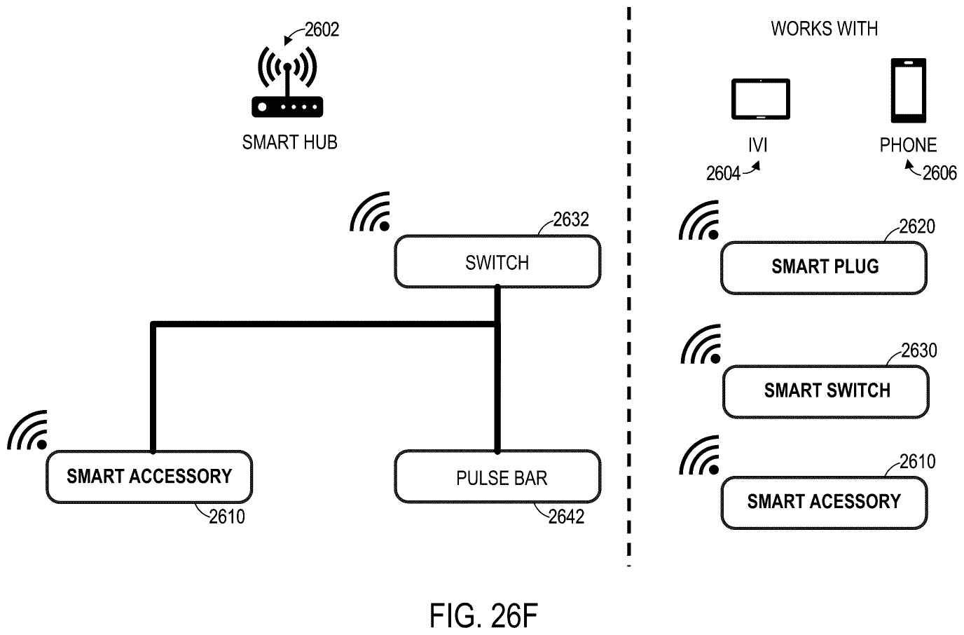

Referring to FIGS. 26A-26F, various embodiments of a wireless smart accessory system are illustrated, according to some embodiments of the present disclosure. FIG. 26A shows a smart hub 2602 configured to communicate via a wireless communication protocol with at least one smart device, such as a smart plug 2620, a smart switch 2630, or a smart accessory 2610. The smart hub 2602 is further configured to receive control inputs from a remote user interface, which may be an in-vehicle infotainment system (IVI) 2604 or a smartphone 2606, and transmit control signals to the smart device to adapt a state of an accessory 2640, 2610 operatively coupled to the smart device.

FIG. 26B illustrates the smart plug 2620 installed inline between a pulse bar 2642 and an accessory 2640. The smart plug 2620 enables wireless control and power monitoring of a traditional accessory by connecting between the pulse bar 2642 and the accessory 2640, without requiring modification to the accessory harness or direct integration with vehicle wiring. For example, an operator with a phone 2606 in communication with the smart hub 2602 is accordingly in communication with the smart plug 2620 and intervening control of the accessor 2640 is thereby permitted.

FIG. 26C depicts a smart switch 2630, which is configured to wirelessly send control inputs to the smart hub 2602. The smart switch 2630 may function as a stand-alone device or as a traditional electromechanical switch 2632, allowing control of accessories 2640 regardless of network status (e.g., through the smart plug 2620 coupled between the pulse bar 2642 and the accessory 2640). The smart switch 2630 may be installed on a dash, steering wheel, or other vehicle surface for convenient access.

FIG. 26D shows a smart accessory 2610, which is controlled by the smart hub 2602 and the smart accessory 2610 may also send data back to the hub. The smart accessory 2610 may provide advanced features such as dynamic activation, power monitoring, or feedback to the user via the IVI 2604 or smartphone 2606. In some embodiments, the smart hub supports dynamic activation, enabling automated changes in operational state based on sensor data, vehicle conditions, or user-defined schedules; power monitoring, allowing real-time measurement and reporting of electrical consumption for connected accessories 2640 and/or smart accessories 2610; and feedback, providing status updates, diagnostic information, and operational alerts to the user through the IVI 2604 or smartphone 2606. The smart accessory 2610 may be grouped with other smart devices for simultaneous control. In some embodiments, the smart hub 2602 is configured to provide simultaneous control of multiple smart accessories 2610 and/or accessories 2640, such that a single user input can coordinate the operation of several accessories-such as turning multiple snow blower chutes in the same direction or activating a group of lights-thereby enabling efficient and unified management of accessory functions.

FIG. 26E illustrates the use of a smartphone 2606 and IVI 2604 as remote user interfaces for the smart hub 2602, enabling wireless control and monitoring of smart devices such as smart plug 2620, smart switch 2630, and smart accessory 2610, as well as accessories 2640. In some embodiments, the smart hub 2602, in conjunction with remote user interfaces such as the IVI 2604 and smartphone 2606, enables wireless control and monitoring of smart devices including the smart plug 2620, smart switch 2630, and smart accessory 2610, as well as traditional accessories 2640 operatively coupled to these smart devices. For example, a user may remotely turn an accessory 2640 or smart accessory 2610 on or off, adjust its operational settings, or monitor its status and power consumption in real time from either the vehicle's infotainment system or a mobile device, without the need for direct physical interaction with the accessory or modification of vehicle wiring. This wireless capability allows for flexible, convenient, and centralized management of both smart and conventional vehicle accessories.

FIG. 26F shows the smart hub 2602 grouping multiple smart devices, such as smart plugs 2620, smart switches 2630, and smart accessories 2610, for simultaneous control and monitoring. The smart hub 2602 is further configured to monitor power usage of the accessories 2610 via the smart devices and to enable automation and dynamic activation of accessories based on user preferences or sensor data. In some embodiments, the smart hub 2602 enables automation and dynamic activation of accessories 2640 and/or smart accessories 2610 based on user preferences or sensor data. For example, the system may automatically activate a smart accessory 2610 or other accessory 2640 when a sensor detects a specific condition, such as low ambient light, vehicle movement, or a scheduled time, as shown in FIG. 26D and described in the associated description herein. This allows for real-time, responsive control of vehicle accessories, enhancing convenience, safety, and operational efficiency.

Across FIGS. 26A-26F, the wireless smart accessory system enables wireless control, grouping, automation, and monitoring of vehicle accessories, without requiring direct integration with vehicle wiring or vehicle control systems. Instead, the wireless smart accessory system is isolated from electrical communication with the vehicle wiring or vehicle control systems. The system supports gradual adoption and retrofit on older vehicles, broad compatibility with existing accessories, and enhanced user experience through remote and in-vehicle user interfaces. For instance, an existing vehicle is readily upgraded with new functionality based on accessories (existing and new), control of functionality (e.g., updated control schemes, control schemes for new accessories), or the like.

The smart hub 2602 may utilize a variety of wireless communication protocols, including low energy radio or Wi-Fi, to facilitate broad compatibility and case of installation. Integration with a vehicle is not required, allowing the system to be retrofitted to older vehicles or used independently of vehicle control systems. However, if available, the smart hub 2602 may also connect to the IVI 2604 for enhanced user interface capabilities.

The smart plug 2620 brings traditional powered accessories, such as light bars, into the smart ecosystem by connecting inline between the pulse bar 2642 and the accessory 2640, using matching connectors for seamless installation without modification to the accessory harness. More advanced versions of the smart plug 2620 may include solid state relays for pulse width modulation, enabling features such as light dimming, or metering components for monitoring energy consumption.

The smart switch 2630 and smart accessory 2610 support both basic on/off functionality and more complex programmable features, such as mode selection, grouped control, and automated activation based on sensor data or user preferences. The smart switch 2630 may be programmed to control multiple functions, including light bar modes or push-to-talk radio buttons, and can operate as a traditional switch 2632 if wireless connectivity is unavailable.

The system's modularity and compatibility with existing accessories and vehicles significantly lower the barrier to entry, allowing users to adopt the system gradually by adding smart devices over time. The architecture supports dynamic grouping of accessories for simultaneous control, remote monitoring and feedback via IVI 2604 or smartphone 2606, and automation features such as scheduled activation or sensor-triggered responses. The wireless smart accessory system thus provides a flexible, scalable, and user-friendly solution for enhancing vehicle accessory functionality without the need for extensive wiring or integration.

### Digital Accessory Mode Selection

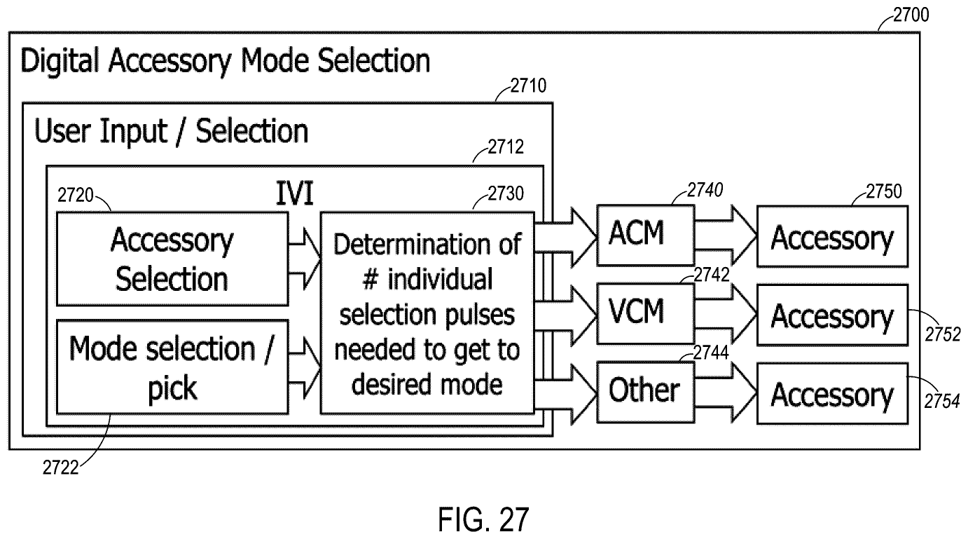

FIG. 27 illustrates a digital accessory mode selection system 2700, which facilitates the process of selecting and adapting modes for various accessories of a vehicle. The process begins with user input or selection 2710, which is provided through an in-vehicle infotainment system (IVI) 2712, in one example. Other user input interfaces, such as smartphones or other control panels, may be used without departing from the scope of the present subject matter. Within the IVI 2712, the user can perform accessory selection 2720 to identify the specific accessory to be controlled, followed by mode selection or pick 2722 to specify the desired operational mode for the selected accessory.

Once the mode is selected, the system determines the number of individual selection pulses needed to transition the accessory from the current mode to the specified mode, as shown in the determination block 2730. This process ensures precise control over the accessory's state.

The determined pulses are then communicated to the accessory control module (ACM) 2740, the vehicle control module (VCM) 2742, or other control systems 2744, depending on the specific architecture of the vehicle. These control modules subsequently transmit the necessary signals to the respective accessories, such as accessory 2750, accessory 2752, and accessory 2754, to adapt their states to the specified mode. This modular and systematic approach enhances the flexibility and efficiency of accessory mode selection and operation.

Further aspects of the digital accessory mode selection method address limitations of conventional systems that require users to repeatedly press a momentary button to cycle through accessory modes, such as those found in light bars or other multi-mode accessories. The present subject matter enables a seamless user experience by allowing a single user input—such as a single press or selection on the IVI 2712—to trigger the controller to automatically determine and transmit the required number of mode selection signals to reach the specified mode. This eliminates the need for multiple manual interactions and reduces user distraction, especially while operating a vehicle. The solution leverages digital communication between the controller and accessories, allowing for rapid and precise mode transitions, and is compatible with both existing hardwired systems and advanced digital architectures. As a result, users benefit from enhanced convenience, improved safety, and a more intuitive interface for controlling accessory functions.

### Accessory Light Audio Module

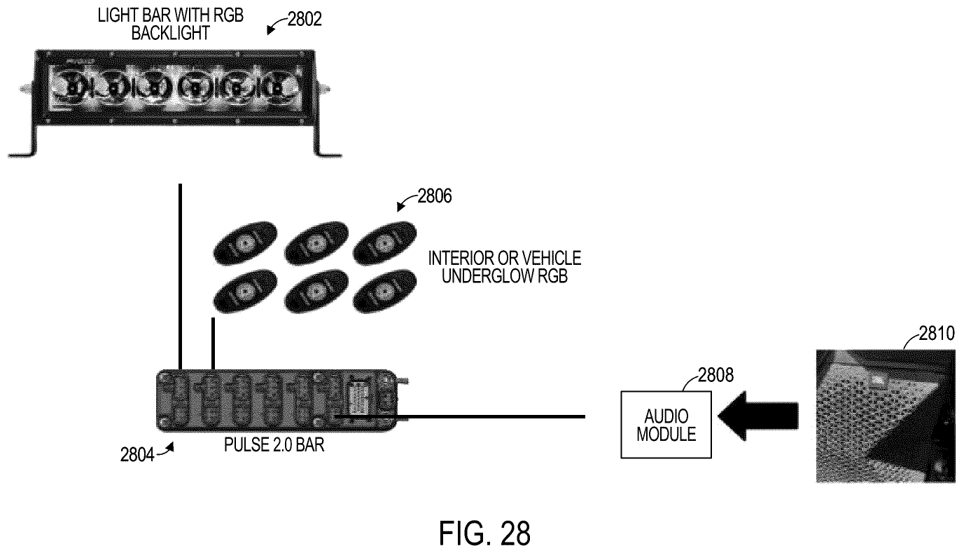

Referring to FIG. 28, an accessory light audio system for a vehicle is illustrated, according to some embodiments of the present disclosure. The system includes a light module, such as a light bar (with or without RGB backlight) 2802 and/or interior or vehicle underglow light (with or without RGB) 2806, configured to emit illumination in response to control signals. An audio module 2808 is mounted in the vehicle and is configured to act as a microphone to process music input from the audio system 2810. The processed audio signal from the audio module 2808 is transmitted to a controller, which may be integrated within the controller, such as a Pulse 2.0 Bar 2804.

The controller 2804 receives the processed audio signal and generates control signals to the light module, such that the illumination produced by the light bar 2802 and/or the interior or vehicle underglow light 2806 is adapted in response to the music input. For example, the lighting may change color, intensity, or pattern based on characteristics of the music, such as rhythm, tempo, or volume. This enables synchronized lighting effects that enhance the audio-visual experience within the vehicle. For example, the lighting produced by the light bar 2802 and interior or vehicle underglow light 2806 may dynamically change color, intensity, or pattern in real time based on characteristics of the music detected by the audio module 2808, such as rhythm, tempo, or volume. In some embodiments, rapid beats in the music may trigger quick flashes or color changes, while slower tempos may result in gradual transitions or softer illumination. Variations in volume can cause the brightness of the lighting to increase or decrease accordingly. This synchronized response between the audio input and the lighting effects creates an immersive audio-visual environment within the vehicle, enhancing the entertainment experience for occupants.

The system supports various permutations, including the use of different types of lighting modules, such as light bars, underglow or interior lights, and the ability to process music input from a variety of audio sources within the vehicle. The audio module 2808 may process music input in real time, allowing dynamic adaptation of the lighting behavior. The integration of these components enables coordinated control of both lighting and audio features, providing a customizable and immersive environment for vehicle occupants.

### Semi-Integrated Bluetooth Control Interface

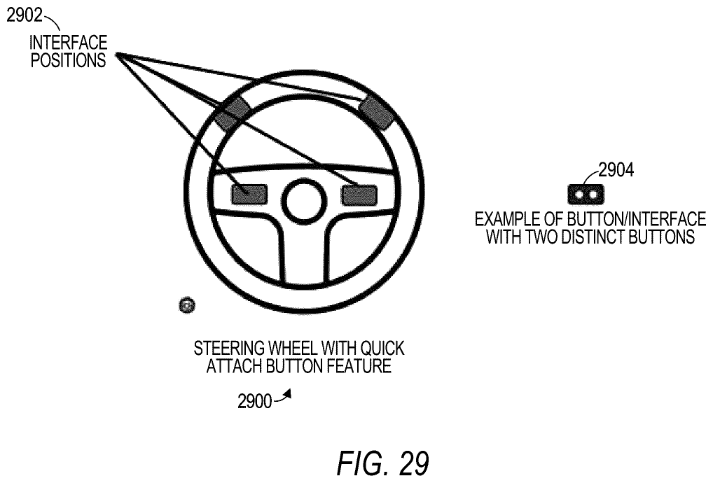

Referring to FIG. 29, an apparatus for semi-integrated Bluetooth control in a vehicle is illustrated, according to some embodiments of the present disclosure. The apparatus includes a Bluetooth-enabled control interface 2904 configured for attachment to a steering wheel 2900 or other accessible vehicle surface at mounting locations 2902. The control interface 2904 may be compatible with a housing or interface location 2902 that is configured to receive and secure one or more user-operable buttons. The steering wheel may include removable covers over button slots or mounting interface locations 2902, which can be removed by the user when installing an interface/button 2904.

A rechargeable battery may be integrated within the control interface 2904, allowing the device to operate wirelessly and be detached from the steering wheel 2900 for recharging as needed. The control interface 2904 is configured to wirelessly transmit control signals to one or more external devices, such as a winch, communication device, action camera, sprayer, or feeder, in response to user actuation of the buttons on the interface.

This apparatus enables convenient and flexible control of vehicle accessories and external devices, allowing users to keep their hands on the steering wheel while operating various functions. The modular design supports easy customization and integration of aftermarket controls, while the rechargeable battery ensures continued wireless operation. The control interface may be a Bluetooth or other wireless type device, and enhances user experience by providing a secure and accessible location for remote control functions, reducing the risk of loss and improving safety and convenience during vehicle operation.

This apparatus enables convenient and flexible control of vehicle accessories and external devices, allowing users to keep their hands on the steering wheel while operating various functions such as winches, communication devices, action cameras, sprayers, or feeders. The modular design of the housing and removable covers allows users to easily customize the control interface by adding or removing user-operable buttons to suit their specific needs or preferences, supporting integration of aftermarket controls. The rechargeable battery ensures continued wireless operation and allows the control interface to be detached from the steering wheel for recharging, further enhancing convenience. By providing a secure and accessible location for remote control functions, the apparatus reduces the risk of losing the remote, improves safety by minimizing driver distraction, and streamlines the operation of both internal and external vehicle accessories during vehicle use.

### Bluetooth Integrated Dash Switch Bank

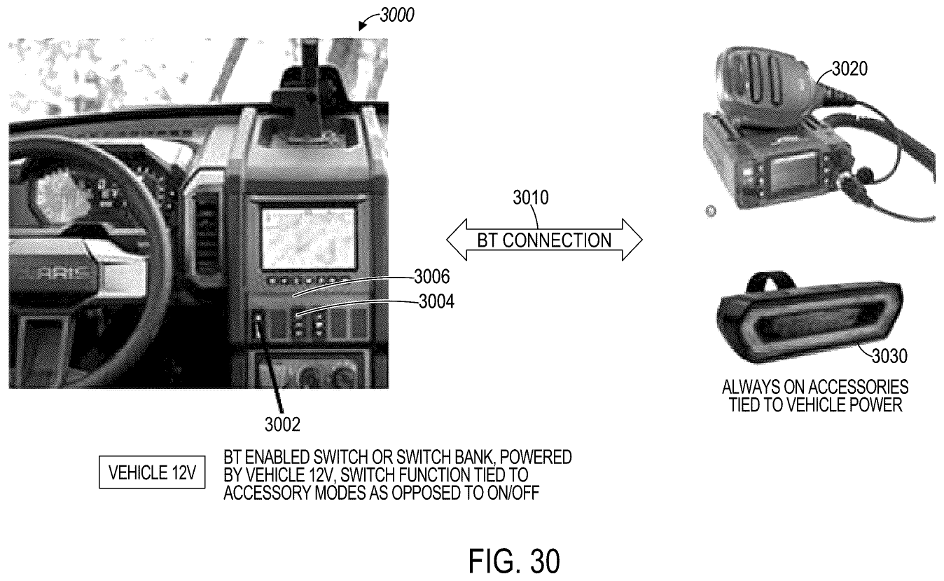

Referring to FIG. 30, a Bluetooth integrated dash switch system for a vehicle is illustrated, according to some embodiments of the present disclosure. The system includes a switch bank 3002 comprising a plurality of user-operable switches 3004, each switch 3004 configured for installation on a vehicle dashboard 3006. The switch bank 3002 is powered via a vehicle power source, such as a 12V supply, and is not physically electrically linked to the accessories 3020, 3030 that it controls. The switch bank 3002 may include only a single switch 3004, in an embodiment.

A Bluetooth communication module 3010 is operatively coupled to the switch bank 3002 and is configured to wirelessly transmit control signals to one or more accessories 3020, 3030 in response to actuation of the switches 3004. The Bluetooth communication module 3010 may be configured to pair with Bluetooth-enabled accessories 3020, 3030 and assign dedicated accessory functions to individual switches 3004, enabling flexible and programmable control. Other types of wireless protocols besides Bluetooth may be used without departing from the scope of the present subject matter. The Bluetooth communication module 3010 may be configured to pair with Bluetooth-enabled accessories 3020 and 3030, allowing users to assign dedicated accessory functions-such as on/off control, mode selection, or push-to-talk radio operation—to individual switches 3004 within the switch bank 3002. This flexible and programmable control enables users to customize the switch bank 3002 to match their specific accessory setup and operational preferences, such as programming one switch 3004 to activate a light bar in a particular mode, while another switch 3004 may be set to control a communication device or initiate a multi-accessory sequence. This configurability supports a wide range of accessory types and functions, enhancing the versatility and user experience of the Bluetooth integrated dash switch system.

The switch bank 3002 supports accessory functions beyond simple on/off operation, including mode selection for light bars or push-to-talk radio operation, in various embodiments. The system is designed for easy installation and may be configured as an aftermarket upgrade to existing vehicle dashboards 3006, allowing users to add wireless accessory control without modifying vehicle wiring or accessory harnesses. The Bluetooth integrated dash switch system provides enhanced convenience, compatibility with a wide range of accessories, and supports advanced functions through wireless communication, improving the user experience and simplifying integration of aftermarket accessories.

The following examples illustrate various embodiments of subject matter described herein.

Example 1: A method for controlling a removable accessory of a vehicle, the method comprising: receiving an indication of a first angle setting for a removable accessory of the vehicle; actuating the removable accessory to a first angle corresponding to the first angle setting; after actuating the removable accessory to the first angle, receiving an indication of the removable accessory not being at the first angle; and re-actuating the removable accessory to the first angle corresponding to the first angle setting.

Example 2: The method of example 1, wherein the removable accessory is a plow.

Example 3: The method of example 1 or 2, wherein the actuating the removable accessory comprises adapting one or more actuators of the vehicle to actuate the removable accessory.

Example 4: The method of example 3, wherein the one or more actuators are hydraulic actuators.

Example 5: The method of any one of examples 1-4, wherein the indication of the first angle setting is received via an infotainment system of the vehicle.

Example 6: The method of any one of examples 1-5, wherein the first angle setting is a maximum angular degree of a range of angular motion of the removable accessory of the vehicle.

Example 7: The method of any one of examples 1-6, wherein the indication of the removable accessory not being at the first angle is received from at least one selected from the group comprising: a limit switch, a hall effect sensor, and a linear potentiometer.

Example 8: A vehicle comprising: a frame; a plurality of ground engaging members coupled to the frame; one or more actuators coupled to the frame; a removable accessory; and a controller storing instructions that, when executed by the controller, cause the controller to perform a set of operations comprising: receiving an indication of a first angle setting for the removable accessory; actuating the removable accessory to a first angle corresponding to the first angle setting, via the one or more actuators; after actuating the removable accessory to the first angle, receiving an indication of the removable accessory not being at the first angle; and re-actuating the removable accessory to the first angle corresponding to the first angle setting, via the one or more actuators.

Example 9: The vehicle of example 8, wherein the removable accessory is a plow.

Example 10: The vehicle of example 8 or 9, wherein the one or more actuators are hydraulic actuators.

Example 11: The vehicle of any one of examples 8-10, wherein the indication of the first angle setting is received via an infotainment system of the recreational vehicle.

Example 12: The vehicle of any one of examples 8-11, wherein the first angle setting is a maximum angular degree of a range of angular motion of the removable accessory of the recreational vehicle.

Example 13: The vehicle of any one of examples 8-12, further comprising at least one selected from the group comprising: a limit switch, a hall effect sensor, and a linear potentiometer, and wherein the indication of the removable accessory not being at the first angle is received from the at least one selected from the group comprising a limit switch, a hall effect sensor, and a linear potentiometer.

Example 14: A method for interfacing accessories with a vehicle, the method comprising: receiving an inbound communication, wherein the inbound communication is received via a first communication protocol; translating the inbound communication into an outbound communication, such that one or more data packets of the inbound communication are readable in the outbound communication via a second communication protocol that is different than the first communication protocol; and transmitting the outbound communication via the second communication protocol.

Example 15: The method of example 14, wherein the first communication protocol comprises one of WiFi, Cellular, Bluetooth, LoRa, J1939, or LIN.

Example 16: The method of example 14 or 15, wherein the inbound communication is received from a first device configured to communicate via the first communication protocol, and wherein the outbound communication is transmitted to a second device configured to communicate via the second communication protocol.

Example 17: The method of example 16, further comprising: pairing with the first device, prior to receiving the inbound communication; and pairing with the second device, prior to transmitting the outbound communication.

Example 18: The method of example 17, wherein the pairing with the first device comprises scanning a first fiducial marker associated with the first device, and wherein the pairing with the second device comprises scanning a second fiducial marker associated with the second device.

Example 19: The method of example 17 or 18, wherein the inbound communication comprises an identifier of the first device, and wherein the method further comprises: reading the identifier from the inbound communication; and pairing with the first device, by storing an indication of the identifier.

Example 20: A vehicle comprising: a frame; a plurality of ground engaging members coupled to the frame; one or more removable accessories; and a controller storing instructions that, when executed by the controller, cause the controller to perform a set of operations comprising: displaying a graphical user interface (GUI), the GUI comprising one or more visual indicators, each visual indicator of the one or more visual indicators corresponding to a respective removable accessory of the one or more removable accessories, and each visual indicator being configurable such that user input corresponding to a first visual indicator of the one or more visual indicators enables adapting a state of a respective first removable accessory corresponding to the first visual indicator; determining to limit configurability of at least one removable accessory of the one or more removable accessories; and limiting the configurability of the at least one removable accessory and also of each visual indicator of the one or more visual indicators that corresponds to a respective removable accessory of the at least one removable accessory.

Example 21: The vehicle of example 20, wherein the determining to limit configurability of at least one removable accessory of the one or more removable accessories comprises: receiving an indication of a user profile corresponding to an operator of the vehicle; determining, based on the user profile, that functionality of the at least one removable accessory of the one or more removable accessories should be limited.

Example 22: The vehicle of example 20 or 21, wherein the determining to limit configurability of at least one removable accessory of the one or more removable accessories comprises: receiving an indication of a state of the vehicle; and determining, based on the vehicle state, that functionality of the at least one removable accessory of the one or more removable accessories should be limited.

Example 23: The vehicle of any one of examples 20-22, wherein the vehicle state comprises one or more selected from the group comprising: a speed of the vehicle, an orientation of the vehicle, and a battery level of the vehicle.

Example 24: The vehicle of any one of examples 20-23, wherein the set of operations further comprises: generating one or more notifications of the configurability of the at least one removable accessory being limited; and displaying the one or more notifications, via the GUI.

Example 25: The vehicle of any one of examples 20-24, wherein the limiting the configurability of the at least one removable accessory comprises disabling the at least one removable accessory from changing states and also disabling each visual indicator corresponding to a respective removable accessory of the at least one removable accessory from changing states.

Example 26: The vehicle of any one of examples 20-25, wherein the removable accessory comprises one or more selected from the group comprising: a winch, a dump bed, a light, and a wiper.

Example 27: The vehicle of any one of examples 20-24 or 26, wherein the limiting the configurability of the at least one removable accessory comprises reducing an amount of states to which the at least one removable accessory can be configured and also reducing an amount of states to which each visual indicator corresponding to a respective removable accessory of the at least one removable accessory can be configured, the reduced amount of states comprising at least two states.

Example 28: A vehicle comprising: a frame; a plurality of ground engaging members coupled to the frame; a plurality of removable accessories; a user interface, the user interface comprising a touchscreen display and a plurality of user input devices; and a controller storing instructions that, when executed by the controller, cause the controller to perform a set of operations comprising: displaying a graphical user interface (GUI), via the touchscreen display, the GUI comprising a plurality of visual indicators, each visual indicator of the plurality of visual indicators being selectable via the touchscreen display; receiving a customized mapping from at least one removeable accessory of the plurality of removeable accessories to both a first visual indicator of the plurality of visual indicators and a first user input device of the plurality of user input devices; and configuring each removeable accessory of the at least one removeable accessories to be adaptable via the first visual indicator and to be adaptable via the first user input device.

Example 29: The vehicle of example 28, wherein the set of operations further comprises: receiving a selection of the first visual indicator; adapting each removeable accessory of the at least one removeable accessories, based on the received selection of the first visual indicator; receiving input via the first user input device; and adapting each removeable accessory of the at least one removeable accessories, based on the received input via the first user input device.

Example 30: The vehicle of example 28 or 29, wherein the customized mapping is a first customized mapping, and wherein the set of operations further comprises: receiving a second customized mapping from a different removable accessory than the at least one removeable accessory to both the first visual indicator of the plurality of visual indicators and the first user input device of the plurality of user input devices; and configuring the different removeable accessory to be adaptable via the first visual indicator and to be adaptable via the first user input device, such that the at least one removeable accessory is no longer adaptable via the first visual indicator or the first user input device.

Example 31: The vehicle of one of examples 28-30, wherein the customized mapping comprises a mapping of only one removeable accessory to only one visual indicator of the plurality of visual indicators and only one user input device of the plurality of user input devices.

Example 32: The vehicle of any one of examples 28-30, wherein the customized mapping comprises a mapping of a plurality of removeable accessories to only one visual indicator of the plurality of visual indicators and only one user input device of the plurality of user input devices.

Example 33: The vehicle of any one of examples 28-32, wherein the set of operations further comprises: receiving an indication of a plurality of removeable accessories being assigned to a group of removeable accessories; storing an indication of the group of removeable accessories in memory, wherein the at least one removeable accessory is the group of removeable accessories.

Example 34: The vehicle of any one of examples 28-33, wherein the removable accessory comprises one or more selected from the group comprising: a winch, a dump bed, a light, and a wiper.

Example 35: A vehicle comprising: a frame; a plurality of ground engaging members coupled to the frame; a plurality of removable accessories; a user interface, the user interface comprising a display; and a controller storing instructions that, when executed by the controller, cause the controller to perform a set of operations comprising: displaying a graphical user interface (GUI), via the display, the GUI comprising a plurality of visual indicators, each visual indicator of the plurality of visual indicators being selectable; receiving a customized mapping from at least a first removeable accessory of the plurality of removeable accessories to a first visual indicator of the plurality of visual indicators and from at least a second removeable accessory of the plurality of removeable accessories to a second visual indicator of the plurality of visual indicators; and configuring each removeable accessory of the at least a first removeable accessory to be adaptable via the first visual indicator and each removable accessory of the at least a second removable accessory to be adaptable via the second visual indicator.

Example 36: The vehicle of example 35, wherein the set of operations further comprises, prior to receiving the customized mapping: displaying a digital library corresponding to the plurality of removeable accessories; and receiving a first selection corresponding to the at least a first removeable accessory, from the digital library, and a second selection corresponding to the at least a second removeable accessory, from the digital library, to configure the customized mapping.

Example 37: The vehicle of any one of examples 35-37, wherein the customized mapping is a first customized mapping corresponding to a first user profile, and wherein the method further comprises receiving a second customized mapping corresponding to a second user profile, the second customized mapping being different than the first customized mapping.

Example 38: The vehicle of any one of examples 35-37, wherein the set of operations further comprises an operator seat defining a center plane extending along a longitudinal axis of the vehicle, wherein the first visual indicator is disposed closer to the center plane than the second visual indicator.

Example 39: The vehicle of example 38, wherein the set of operations further comprises: tracking a usage of the first visual indicator and the second visual indicator; determining that the second visual indicator mapped to the second removeable accessory is selected more often than the first visual indicator mapped to the first removeable accessory; and updating the second removeable accessory to be mapped to the first visual indicator, instead of the first removeable accessory being mapped to the first visual indicator.

Example 40: A vehicle comprising: a frame; a plurality of ground engaging members coupled to the frame; a controller area network (CAN) bus; an accessory controller in communication with the CAN bus, the accessory controller comprising a processor and memory; and a plurality of removable accessories operatively coupled to the accessory controller, wherein the accessory controller is configured to receive one or more communications from the CAN bus to adapt at least one of the plurality of removeable accessories.

Example 41: The vehicle of example 40, wherein the accessory controller comprises: a primary accessory control module comprising its own processor and memory; and at least one secondary accessory control module comprising its own processor and memory, the at least one secondary accessory control module being in communication with the primary accessory control module and in communication with the CAN bus via the primary accessory control module, wherein the plurality of removeable accessories are operatively coupled to the at least one secondary accessory control module, and wherein the primary accessory control module is configured to receive one or more communications from the CAN bus to instruct the at least one secondary accessory control module to adapt the at least one of the plurality of removeable accessories.

Example 42. The vehicle of example 41, further comprising a battery, wherein the CAN bus, the primary accessory control module, and the secondary accessory control module are all powered by the battery.

Example 43: The vehicle of example 41 or 42, wherein the at least one secondary accessory control module comprises a plurality of secondary accessory control modules that are operatively coupled together, such that the output of a first of the secondary accessory control modules is the input for a second of the secondary accessory control modules.

Example 44: The vehicle of any one of examples 40-43, wherein the accessory controller comprises a wireless communication module, and the accessory controller is configured to: receive, wirelessly from a remote device, one or more signals for adapting the at least one of the plurality of removeable accessories; and cause the at least one of the plurality of removeable accessories to be adapted.

Example 45: The vehicle of example 44, wherein the causing the at least one of the plurality of removeable accessories to be adapted comprises changing the at least one of the plurality of removeable accessories between an off state and an on state.

Example 46: The vehicle of any one of examples 40-45, wherein the plurality of removable accessories comprise one or more selected from the group comprising: a winch, a dump bed, a light, a plow, a sprayer, and a wiper.

Example 47: A vehicle comprising: a frame; a plurality of ground engaging members coupled to the frame; a controller area network (CAN) bus; an accessory controller in communication with the CAN bus, the accessory controller comprising a processor and memory; a plurality of removable accessories operatively coupled to the accessory controller; and one or more input devices operatively coupled to the accessory controller, wherein the one or more input devices are configured to transmit one or more communications, via the accessory controller, to adapt at least one of the plurality of removeable accessories.

Example 48: The vehicle of example 47, wherein the one or more input devices comprises one or more selected from the group comprising: a switch, a button, a joystick, and a dial.

Example 49: The vehicle of example 47 or 48, wherein the plurality of removable accessories comprise one or more selected from the group comprising: a winch, a dump bed, a light, a plow, a sprayer and a wiper.

Example 50: The vehicle of any one of examples 47-49, wherein the accessory controller comprises: a primary accessory control module comprising its own processor and memory; and at least one secondary accessory control module comprising its own processor and memory, the at least one secondary accessory control module being in communication with the primary accessory control module and in communication with the CAN bus via the primary accessory control module, wherein the one or more input devices are operatively coupled to the at least one secondary accessory control module.

Example 51: A vehicle comprising: a frame; a plurality of ground engaging members coupled to the frame; a controller area network (CAN) bus; an accessory controller in communication with the CAN bus, the accessory controller comprising a processor and memory; and a plurality of removable accessories operatively coupled to the accessory controller, the plurality of removable accessories comprising an auxiliary power source, the auxiliary power source being configured to power at least one other removable accessory of the plurality of removable accessories via the accessory controller.

Example 52: The vehicle of example 51, wherein the accessory controller is configured to receive one or more communications from the CAN bus to adapt at least one of the plurality of removeable accessories.

Example 53: The vehicle of example 51 or 52, wherein the auxiliary power source is an auxiliary battery.

Example 54: The vehicle of any one of examples 51-53, further comprising a vehicle battery, wherein the auxiliary power is configured to power the at least one other removable accessory of the plurality of removable accessories independent of the vehicle battery.

Example 55: The vehicle of any one of examples 51-54, wherein the accessory controller comprises a wireless communication module, and the accessory controller is configured to: receive, wirelessly from a remote device, one or more signals for adapting the at least one of the plurality of removeable accessories; and cause the at least one of the plurality of removeable accessories to be adapted.

Example 56: The vehicle of example 55, wherein the causing the at least one of the plurality of removeable accessories to be adapted comprises changing the at least one of the plurality of removeable accessories between an off state and an on state.

Example 57: The vehicle of any one of examples 51-56, wherein the plurality of removable accessories further comprise one or more selected from the group comprising: a winch, a dump bed, a light, and a wiper.

Example 58: A method for configuring an accessory controller for a vehicle, the method comprising: providing the accessory controller for the vehicle, the accessory controller comprising a processor, a memory, and a plurality of ports, each port of the plurality of ports being sized and shaped to receive a respective coupling with a removable accessory of the vehicle; receiving, at a first port of the plurality of ports, a coupling with a first removable accessory of the vehicle; displaying a port configuration user interface on a display screen of the vehicle; receiving an indication of one or more inputs on the port configuration user interface; and customizing adaptability of the first removable accessory, based on the received indication of one or more inputs on the port configuration user interface.

Example 59: The method of example 58, wherein the first removable accessory comprises one or more selected from the group comprising: a winch, a dump bed, a light, a sprayer, and a wiper.

Example 60: The method of example 58 or 59, wherein the indication of the one or more inputs on the port configuration user interface comprises one or more selected from the group comprising: a vehicle gear position, a vehicle temperature, a hand control, and a vehicle speed.

Example 61: The method of any one of examples 58-60, wherein the indication of the one or more inputs on the port configuration user interface comprises a vehicle gear position, a vehicle temperature, a hand control, and a vehicle speed.

Example 62: The method of any one of examples 58-61, further comprising: detecting an occurrence of one or more conditions of the vehicle corresponding to the received indication of one or more inputs on the port configuration user interface; and adapting the first removable accessory, based on the detection of the occurrence of the one or more conditions of the vehicle.

Example 63: A method for intelligent plowing with a vehicle, the method comprising receiving, at a controller of the vehicle, operator input specifying a desired plowing outcome, the operator input including at least one of a predetermined location or direction for plowed material; determining, based on vehicle position or orientation data, a plow position and angle required to achieve the specified plowing outcome; automatically actuating the plow to the determined position and angle; and adjusting the plow position and angle in real time as the vehicle moves, based on updated vehicle position or orientation data, to continuously direct plowed material toward the specified location or direction.

Example 64: The method of example 63, wherein the operator input further includes a selection between standard plowing and backplowing modes.

Example 65: The method of any one of examples 63-64, wherein the vehicle position or orientation data is obtained from a location sensor or a direction sensor integrated with the vehicle.

Example 66: The method of any one of examples 63-66, further comprising displaying, on a user interface of the vehicle, a visual indication of the current plow position and the direction in which material is being pushed.

Example 67: A wireless smart accessory system for a vehicle, the system comprising: a wireless hub configured to communicate with at least one smart device via a wireless communication protocol, the smart device comprising at least one of a smart plug, a smart relay, a smart switch, or a smart accessory; wherein the wireless hub is configured to receive control inputs from a remote user interface and transmit control signals to the smart device to adapt a state of at least one accessory operatively coupled to the smart device, without requiring direct integration with vehicle wiring or vehicle control systems.

Example 68: The system of example 67, wherein the wireless hub is further configured to group multiple smart devices for simultaneous control and to monitor power usage of the accessory via the smart device.

Example 69: The system of any one of examples 67-68, wherein the remote user interface comprises a mobile device or an in-vehicle infotainment system operatively connected to the wireless hub.

Example 70: The system of any one of examples 67-69, wherein the smart plug is configured to enable wireless control and power monitoring of a traditional accessory by connecting inline between a power source and the accessory.

Example 71: A method for digital accessory mode selection in a vehicle, the method comprising: receiving, at a controller, a user input indicating a specified mode for an accessory; determining, based on a current mode of the accessory, a required number of mode selection signals to transition the accessory from the current mode to the specified mode; and automatically transmitting the required number of mode selection signals from the controller to the accessory to transition the accessory to the specified mode in response to the single user input.

Example 72: The method of example 71, wherein the user input is received via a graphical user interface of an in-vehicle infotainment system.

Example 73: The method of any one of examples 71-72, wherein the accessory is a light bar having a plurality of selectable modes.

Example 74: The method of any one of examples 71-73, wherein the controller is configured to transmit the mode selection signals as digital commands over a vehicle communication network.

Example 75: An accessory light audio system for a vehicle, the system comprising: a light module configured to emit illumination in response to control signals; an audio module configured to be mounted in the vehicle and configured to process music input; and a controller operatively coupled to the light module and the audio module, the controller configured to receive a processed audio signal from the audio module and to generate control signals to send to the light module, such that the illumination is adapted in response to the music input.

Example 76: The system of example 75, wherein the light module comprises a red-green-blue (RGB) light configured to emit variable color illumination based on characteristics of the processed audio signal.

Example 77: The system of example 75, wherein the light module comprises an interior vehicle light.

Example 78: The system of example 75, wherein the light module comprises one or more of an underglow light or a light bar.

Example 79: An apparatus for semi-integrated wireless control in a vehicle, comprising: a wireless control interface including on or more buttons configured for attachment to a steering wheel or other accessible vehicle surface; a housing configured to receive and secure the wireless control interface; and a rechargeable battery integrated within the housing of the wireless control interface; wherein the wireless control interface is configured to wirelessly transmit control signals to one or more external devices in response to user actuation of the buttons.

Example 80: The apparatus of example 79, wherein the control interface is configured to be detached from the steering wheel or other accessible vehicle surface for recharging the battery.

Example 81: The apparatus of any of examples 79-80, wherein the control signals are configured to control at least one of a winch, a communication device, an action camera, a sprayer or a feeder.

Example 82: The apparatus of any of examples 79-81, wherein the wireless control interface includes a Bluetooth control interface.

Example 83: A Bluetooth integrated dash switch system for a vehicle, comprising: a switch bank comprising a plurality of user-operable switches, the switch bank configured for installation on a vehicle dashboard; a Bluetooth communication module operatively coupled to the switch bank and configured to wirelessly transmit control signals to one or more accessories in response to actuation of the switches; wherein the switch bank is powered via a vehicle power source and is not physically electrically linked to the accessories.

Example 84: The system of example 83, wherein the Bluetooth communication module is configured to pair with Bluetooth-enabled accessories and assign dedicated accessory functions to individual switches.

Example 85: The system of any of examples 83-84, wherein the at least one of the plurality of user-operable switches is configured to for push-to-talk radio operation.

Example 86: The system of any of examples 83-85, wherein the switch bank is configured to be installed as an aftermarket upgrade to existing vehicle dashboards.

The above detailed description of the present disclosure and the examples described therein have been presented for the purposes of illustration and description only and not by limitation. It is therefore contemplated that the present disclosure covers any and all modifications, variations or equivalents that fall within the scope of the basic underlying principles disclosed above and claimed herein.

What is claimed is:

1. A method for controlling a removable accessory of a vehicle, the method comprising:
receiving an indication of a first angle setting for a removable accessory of the vehicle;
actuating the removable accessory to a first angle corresponding to the first angle setting;
after actuating the removable accessory to the first angle, receiving an indication of the removable accessory not being at the first angle; and
re-actuating the removable accessory to the first angle corresponding to the first angle setting.

2. The method of claim 1, wherein the removable accessory is a plow.

3. The method of claim 1, wherein the actuating the removable accessory comprises adapting one or more actuators of the vehicle to actuate the removable accessory.

4. The method of claim 3, wherein the one or more actuators are hydraulic actuators.

5. The method of claim 1, wherein the indication of the first angle setting is received via an infotainment system of the vehicle.

6. The method of claim 1, wherein the first angle setting is a maximum angular degree of a range of angular motion of the removable accessory of the vehicle.

7. The method of claim 1, wherein the indication of the removable accessory not being at the first angle is received from at least one selected from the group comprising: a limit switch, a hall effect sensor, and a linear potentiometer.

8. A vehicle comprising:
a frame;
a plurality of ground engaging members coupled to the frame;
one or more actuators coupled to the frame;
a removable accessory; and
a controller storing instructions that, when executed by the controller, cause the controller to perform a set of operations comprising:
receiving an indication of a first angle setting for the removable accessory;
actuating the removable accessory to a first angle corresponding to the first angle setting, via the one or more actuators;
after actuating the removable accessory to the first angle, receiving an indication of the removable accessory not being at the first angle; and
re-actuating the removable accessory to the first angle corresponding to the first angle setting, via the one or more actuators.

9. The vehicle of claim 8, wherein the removable accessory is a plow.

10. The vehicle of claim 8, wherein the one or more actuators are hydraulic actuators.

11. The vehicle of claim 8, wherein the indication of the first angle setting is received via an infotainment system of the vehicle.

12. The vehicle of claim 8, wherein the first angle setting is a maximum angular degree of a range of angular motion of the removable accessory of the vehicle.

13. The vehicle of claim 8, further comprising at least one selected from the group comprising: a limit switch, a hall effect sensor, and a linear potentiometer, and
wherein the indication of the removable accessory not being at the first angle is received from the at least one selected from the group comprising a limit switch, a hall effect sensor, and a linear potentiometer.

14. A method for interfacing accessories with a vehicle, the method comprising:
receiving an inbound communication, wherein the inbound communication is received via a first communication protocol;
translating the inbound communication into an outbound communication, such that one or more data packets of the inbound communication are readable in the outbound communication via a second communication protocol that is different than the first communication protocol; and
transmitting the outbound communication via the second communication protocol.

15. The method of claim 14, wherein the first communication protocol comprises one of WiFi, Cellular, Bluetooth, LoRa, J1939, or LIN.

16. The method of claim 14, wherein the inbound communication is received from a first device configured to communicate via the first communication protocol, and wherein the outbound communication is transmitted to a second device configured to communicate via the second communication protocol.

17. The method of claim 16, further comprising:
pairing with the first device, prior to receiving the inbound communication; and
pairing with the second device, prior to transmitting the outbound communication.

18. The method of claim 17, wherein the pairing with the first device comprises scanning a first fiducial marker associated with the first device, and wherein the pairing with the second device comprises scanning a second fiducial marker associated with the second device.

19. The method of claim 17, wherein the inbound communication comprises an identifier of the first device, and wherein the method further comprises:
reading the identifier from the inbound communication; and
pairing with the first device, by storing an indication of the identifier.

20. A vehicle comprising:
a frame;
a plurality of ground engaging members coupled to the frame;
one or more removable accessories; and
a controller storing instructions that, when executed by the controller, cause the controller to perform a set of operations comprising:
displaying a graphical user interface (GUI), the GUI comprising one or more visual indicators, each visual indicator of the one or more visual indicators corresponding to a respective removable accessory of the one or more removable accessories, and each visual indicator being configurable such that user input corresponding to a first visual indicator of the one or more visual indicators enables adapting a state of a respective first removable accessory corresponding to the first visual indicator;
determining to limit configurability of at least one removable accessory of the one or more removable accessories; and
limiting the configurability of the at least one removable accessory and also of each visual indicator of the one or more visual indicators that corresponds to a respective removable accessory of the at least one removable accessory.

21. The vehicle of claim 20, wherein the determining to limit configurability of at least one removable accessory of the one or more removable accessories comprises:
receiving an indication of a user profile corresponding to an operator of the vehicle;
determining, based on the user profile, that functionality of the at least one removable accessory of the one or more removable accessories should be limited.

22. The vehicle of claim 20, wherein the determining to limit configurability of at least one removable accessory of the one or more removable accessories comprises:
receiving an indication of a state of the vehicle; and
determining, based on the vehicle state, that functionality of the at least one removable accessory of the one or more removable accessories should be limited.

23. The vehicle of claim 22, wherein the vehicle state comprises one or more selected from the group comprising: a speed of the vehicle, an orientation of the vehicle, and a battery level of the vehicle.

24. The vehicle of claim 20, wherein the set of operations further comprises:
generating one or more notifications of the configurability of the at least one removable accessory being limited; and
displaying the one or more notifications, via the GUI.

25. The vehicle of claim 20, wherein the limiting the configurability of the at least one removable accessory comprises disabling the at least one removable accessory from changing states and also disabling each visual indicator corresponding to a respective removable accessory of the at least one removable accessory from changing states.

26. The vehicle of claim 20, wherein the removable accessory comprises one or more selected from the group comprising: a winch, a dump bed, a light, and a wiper.

27. The vehicle of claim 20, wherein the limiting the configurability of the at least one removable accessory comprises reducing an amount of states to which the at least one removable accessory can be configured and also reducing an amount of states to which each visual indicator corresponding to a respective removable accessory of the at least one removable accessory can be configured, the reduced amount of states comprising at least two states.
